(19) United States
(12) Patent Application Publication
(10) Pub. No.: US 2005/0072808 A1
(43) Pub. Date: Apr. 7, 2005

(54) Pump with function of measuring fixed amount

(76) Inventor: Sachiko Kitamura, Chuo-ku (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/497,080

(22) PCT Filed: Nov. 12, 2002
(86) PCT No.: PCT/JP02/11811

(30) Foreign Application Priority Data
Nov. 30, 2001 (JP) 2001-366781
Dec. 26, 2001 (JP) 2001-394935
Dec. 26, 2001 (JP) 2001-394936
Dec. 26, 2001 (JP) 2001-394937
Nov. 7, 2002 (JP) 2002-323800

(51) Int. Cl. G01F 11/06

(52) U.S. Cl. 222/309

(57) ABSTRACT

A push-down liquid pump that forms a part of a lid body of a liquid container and pumps up a fixed amount of liquid from inside of a container main body by push-down operation. A stopper for limiting the push-down amount of the push-down portion is arranged movably in a space provided for the movement of the pump push-down portion in such a way that the movement amount of the stopper is adjustable by moving the stopper in a position between a maximum movement amount position and immobile position. This enables a fixed amount of liquid corresponding to the push-down amount of the push-down portion to be dispensed.

### TECHNICAL FIELD

The present invention relates to a hand pump for measuring and dispensing a fixed amount of liquid from a liquid container, more specifically, a pump with a function of measuring a fixed amount in a way that the amount to be measured can be arbitrarily set and the amount to be discharged is adjustable.

### BACKGROUND ART

Recently, as a shampoo or cleanser container, a liquid container with a pump which includes a hand pump forming a part of a lid body has come into wide use. Detailed construction of the pump is various, and basically, it has two check valves on the upper and lower portions of a piston connected from a pushing portion inside a cylinder by a connecting rod, and the piston is provided with a push-back means such as a spring in its basic structure.

When it acts, the piston lowers inside the cylinder when the pushing portion is pushed down, this action increases the inner pressure of the lower side of the piston inside the cylinder, and accordingly, the check valve of the suction side (container side) closes and the check valve of the discharge side opens to discharge liquid from a discharge opening. When the piston is pushed up by the push-back spring, the check valve of the discharge side closes, the check valve of the suction side opens, and liquid is suctioned from the inside of the container due to a negative pressure generated at the lower side of the piston inside the cylinder and fills the cylinder for the next discharge process. Such a pump-type container has come into wide use with the reason that fixed amount discharge is easy, that it is possible to increase the capacity of the container in comparison with a conventional tube-type container or liquid container without a pump, and that liquid can be easily pumped out with one hand.

However, the prior arts have the following problems.

First, the amount to be dispensed (discharged) per one stroke of the piston determined in design is not changeable. Structurally, it is not impossible to dispense an amount smaller than the designed amount to be dispensed by adjusting the push-down amount of the piston, however, it is not possible to constantly dispense an accurate fixed amount.

Second, the pump-type container is not always a high-capacity container but also employed as a small-capacity container that is mainly used for cosmetics, etc., and it is not unusual that such a container is carried about.

However, the conventional pump is normally in a standby mode ready for discharge, so that the contents stored in advance in the cylinder are discharged at the moment when the push-down portion is pushed down. This is undesirable discharge, and not only contaminates the surroundings but also wastes an amount of liquid corresponding to one time of discharge. Furthermore, there is a possibility that the push-down portion is carelessly pushed down during the distribution process, and this is acknowledged as a problem.

In order to solve these problems, conventionally, the following proposals have been made.

For the first problem, for example, a utility model (hereinafter, referred to as Prior Art 1) disclosed in Japanese Utility Model Application Unexamined Publication No. H05-94148 has been proposed. In this utility model, the squeeze width (stroke) is set in several steps by a projection provided on a knob of a pump and a stepped member inside the holder so that the amount to be discharged is changeable to some extent.

However, in this Prior Art 1, the knob (pump head) is rotated according to the steps, and no means for limiting the rotation of the knob at a predetermined position is provided. Therefore, when the knob is pushed down by hand, depending on the force applying direction for pushing down the knob, the knob can rotate and come off a desired step. Therefore, this Prior Art 1 cannot solve the second problem.

Furthermore, Japanese Utility Model Application Unexamined Publication No. S61-90754 (hereinafter, referred to as Prior Art 2) discloses a dropper having a combination of an inclined plate and an inclined projection opposite to each other. In this construction, the inclined plate and the inclined projection are provided in a rotatable manner, and the butting distance between them is changed to change the amount of liquid to be suctioned. Due to their inclined surfaces, the inclined plate and the inclined projection rotate while slipping down each other when they butt against each other, however, by engagement between vertical threads and notches, they are made to freely move up and down and not to rotate.

However, a guide cylinder for limiting the rotation of the working body is formed rotatably with respect to an assembled cylinder, and as a result, the rotation restraining function of the inclined plate and the inclined projection becomes unable to function depending on the strength of the push-down force of the working body, so that accurate measurement is not possible. Furthermore, the amount to be measured is changed by pushing-down and rotating the working body, and this cannot be applied to a structure in which contents are discharged by a push-down operation. The above-described art is applicable only for a dropper. The second problem cannot be solved even by this Prior Art 2.

On the other hand, as a means for solving the second problem, first, for a pump head locking means, as shown in FIG. 62, it has been common that a screw is formed at the lower portion of the pump head, and the pump head is screwed into and locked on the cylinder upper portion while it is pushed down. This is effective during the process of distribution since the pump is assembled to a container main body while the pump is pushed down at the point of factory shipment.

However, after one time of dispensing, the pump head is always at the raised position, so that in order to lock the pump head at the same lowered position when not being used, the contents of the container must be discharged once. Therefore, as a method for normally positioning the pump head at the raised position even during the process of distribution, as described in the invention of Japanese Patent Application Unexamined Publication No. 2001-180774, a method for prohibiting lowering of the pump head by fitting a clip type sleeve to the neck portion under the pump head was proposed. In this method, it is possible to lock the lowering movement of the pump head without discharge of the contents accumulated inside the cylinder. However, this method has the problem that the sleeve is easily lost.

As mentioned above, the prior arts could not solve the above-described problems simultaneously.

Therefore, the invention solves the above-described prior art problems by providing a pump with a function of measuring a fixed amount of liquid in a manner that an amount to be discharged is adjustable, and the invention provides a pump with high usability and versatility by realizing both free changes in the amount to be measured and reliable maintenance of the amount, and secure fixation of the pump head.

### DISCLOSURE OF THE INVENTION

Accordingly, the pump of the invention, having a function of measuring a fixed amount in a way that the amount to be discharged is adjustable, has the following features.

(1) In a push-down liquid pump that forms a part of a lid body of a liquid container and dispenses and discharges a fixed amount of liquid from inside of a container main body by a push-down operation of a pump head, the pump comprises
a pump head that lowers when the pump head is pushed down,
a movable member that lowers together with the pump head, and
a means for limiting the push-down amount of the pump head, which is provided for the pump head and the movable member in a movable manner so that the amount to be pushed down of the pump head is adjustable between zero and the maximum, whereby a fixed amount corresponding to the push-down amount of the pump head is measured, dispensed and discharged.

(2) The push-down amount limiting means of the pump head has a freely extensible means which makes the lower end of the pump head extensible downward, and the pump head push-down amount is adjusted by the freely extensible means in a range from zero to the maximum according to the amount of lowering of the lower end of the pump head.

(3) The push-down amount limiting means of the pump head comprises a stopper, which is provided in a movable manner for a connecting tube that connects the pump head and a piston inside a pump cylinder, so that the stopper limits an entering amount of the connecting tube into the pump cylinder when the pump head is pushed down and adjusts the pump head push-down amount in a range from zero to the maximum by means of the stopper position according to the entering amount of the connecting tube.

(4) The push-down amount adjusting mechanism of the push-down amount limiting means of the pump head enables stepless adjustments by screwing the movable stopper and its supporting member together.

(5) The supporting member rotatably supports the stopper and, on its outer circumference at a desired portion, is provided with engageable portions at arbitrarily divided positions of the outer circumference, and the stopper is provided with an engaging means that engages with the engageable portions, whereby a moderate feeling is given to the rotation of the stopper.

(6) The push-down amount limiting means of the pump head has such a push-down amount adjusting mechanism that each of the movable stopper and its supporting member is provided with an alternative of a comb-shaped groove or a projection that engages with the groove and moves within the groove in a reciprocal manner, and the projection is engaged with the comb-shaped groove at a projection fixing position to move the stopper in a stepped manner for adjustment.

(7) The push-down amount limiting means of the pump head has such a push-down amount adjusting mechanism that each of the movable stopper and its supporting member is provided with an alternative of a projecting thread or a thread groove row that engages with the projecting thread in a reciprocal manner, and the projecting thread is engaged with an arbitrary thread groove of the thread groove row to move the stopper in a stepped manner for adjustment.

(8) The push-down amount limiting means of the pump head has such a push-down amount adjusting mechanism that the stopper supporting member is provided with a thread groove row and the movable stopper is provided with an engaging means that engages with the thread groove row, and the engaging means is engaged with an arbitrary thread groove of the thread groove row to move the stopper in a stepped manner for adjustment.

(9) The stopper is formed into a plate shape and the engaging means is a notch that fits the cross sectional shape of the thread groove bottom portion, and the stopper is inserted into and engaged with an arbitrary thread groove.

(10) The stopper is formed into an annular shape from an elastic material and constructed so that portions opposite each other of the annular shape sandwich a cross sectional shape of the thread groove bottom portion in normal conditions, and the engaging means elastically deforms the stopper to make and release the engagement with the thread groove.

(11) The engaging means is structured so as to pinch the cross sectional shape of the thread groove bottom portion in a movable manner.

(12) The push-down amount limiting means of the pump head has such a push-down amount adjusting mechanism that an engaging hole row is made in the stopper supporting member, an engaging means that engages with any one engaging hole of the engaging hole row is provided for the movable stopper, and the engaging means is engaged with an arbitrary engaging hole of the engaging hole row, whereby the stopper is moved in a stepped manner for adjustment.

(13) In a push-down liquid pump that forms a part of a lid body of a liquid container and dispenses and discharges a fixed amount of liquid from inside of a container main body by a push-down operation of a pump head, the pump comprises
a pump head,
a fixing member to be fixed to a container main body, which does not move with the pump head when the pump head is pushed down,
and a means for limiting the push-down amount of the pump head, which is provided for the fixing member in a movable manner so that the pump head push-down amount is adjustable between zero and the maximum, whereby a fixed amount according to the push-down amount of the pump head is measured, dispensed and discharged.

(14) The push-down amount limiting means of the pump head comprises
a cylindrical body, which is to stand up from an opening of a container main body and
a stopper, which is movable upward and downward by using the cylindrical body as a shaft so that the push-down amount of the pump head is adjusted in a range from zero to the maximum according to the position of the stopper.

(15) The push-down amount limiting means of the pump head comprises
a lid body of a container main body; and
a stopper, which is movable upward and downward by using the lid body as a shaft so that the push-down amount of the pump head is adjusted in a range from zero to the maximum according to the position of the stopper.

(16) The push-down amount limiting means of the pump head comprises
a cylindrical portion, which is to be provided at a center of an opening of a container main body; and
a stopper, which is pivotally supported by the cylindrical portion so that the push-down amount of the pump head is adjusted in a range from zero to the maximum according to the position of the stopper.

(17) The push-down amount adjusting mechanism of the push-down amount limiting means of the pump head enables stepless adjustments by screwing the movable stopper and its supporting member together.

(18) The supporting member rotatably supports the stopper and, on its outer circumference at a desired portion, is provided with engageable portions at arbitrarily divided positions of the outer circumference, and the stopper is provided with an engaging means that engages with the engageable portions, whereby a moderate feeling is given to the rotation of the stopper.

(19) The push-down amount limiting means of the pump head has such a push-down amount adjusting mechanism that each of the movable stopper and its supporting member is provided with an alternative of a comb-shaped groove or a projection that engages with the groove and moves within the groove in a reciprocal manner, and the projection is engaged with the comb-shaped groove at a projection fixing position to move the stopper in a stepped manner for adjustment.

(20) The push-down amount limiting means of the pump head has such a push-down amount adjusting mechanism that each of the movable stopper and its supporting member is provided with an alternative of a projecting thread or a thread groove row that engages with the projecting thread in a reciprocal manner, and the projecting thread is engaged with an arbitrary thread groove of the thread groove row to move the stopper in a stepped manner for adjustment.

(21) The push-down amount limiting means of the pump head has such a push-down amount adjusting mechanism that the stopper supporting member is provided with a thread groove row and the movable stopper is provided with an engaging means that engages with the thread groove row, and the engaging means is engaged with an arbitrary thread groove of the thread groove row to move the stopper in a stepped manner for adjustment.

(22) The stopper is formed into a plate shape and the engaging means is a notch that fits the cross sectional shape of the thread groove bottom portion, and the stopper is inserted into and engaged with an arbitrary thread groove.

(23) The stopper is formed into an annular shape from an elastic material and constructed so that portions opposite each other of the annular shape sandwich a cross sectional shape of the thread groove bottom portion in normal conditions, and the engaging means elastically deforms the stopper to make and release the engagement with the thread groove.

(24) The engaging means is structured so as to pinch the cross sectional shape of the thread groove bottom portion in a movable manner.

(25) The push-down amount limiting means of the pump head has such a push-down amount adjusting mechanism that an engaging hole row is made in the stopper supporting member, an engaging means that engages with any one engaging hole of the engaging hole row is provided for the movable stopper, and the engaging means is engaged with an arbitrary engaging hole of the engaging hole row, whereby the stopper is moved in a stepped manner for adjustment.

(26) In a pump with a function of measuring a fixed amount in a way that the amount to be discharged is adjustable in a stepped manner, which is a push-down liquid pump that forms a part of a lid body of a liquid container and pumps up a fixed amount of liquid from the inside of the container main body in response to push-down operation, and is provided with a stopper that limits the push-down amount of the push-down portion provided in a movable manner in a movement space of the pump push-down portion so that the movement amount is adjustable in a stepped manner between a maximum movement amount and an immobile position to measure and dispense a fixed amount corresponding to the push-down amount of the push-down portion,
the stopper is a projection projectedly provided on an outer wall of a tubular member enveloping a connecting tube that connects a pump head and a piston,
the pump head is provided with a plurality of vertical grooves having different lengths, each of which is engageable with the projection to allow the projection to slide vertically, and
when the pump head is pushed down upon fitting the positions of the projection and desired one of the vertical grooves by rotating the pump head, the pump head is pushed down with a stroke limited according to the length of the vertical groove.

(27) In a pump with a function for measuring a fixed amount in a way that the amount to be discharged is adjustable in a stepped manner, which is a push-down liquid pump that forms a part of a lid body of a liquid container and pumps up a fixed amount of liquid from the inside of the container main body in response to push-down operation, and is provided with a stopper that limits the push-down amount of the push-down portion provided in a movable manner in a movement space of the pump push-down portion so that the movement amount is adjustable in a stepped manner between a maximum movement amount and an immobile position to measure and dispense a fixed amount corresponding to the push-down amount of the push-down portion,
the stopper is a projection projectedly provided on an outer wall of a pump head outer cylinder,
a cylindrical body into which the pump head is to be inserted inserted is provided on a container lid body,
the cylindrical body is provided with a plurality of vertical grooves having different lengths, each of which is engageable with the projection to allow the projection to slide vertically, and
when the pump head is pushed down upon fitting the positions of the-projection and desired one of the vertical grooves by rotating the pump head, the pump head is pushed down with a stroke limited according to the length of the vertical groove.

(28) In a pump with a function for measuring a fixed amount in a way that the amount to be discharged is adjusted in a stepped manner, which is a push-down liquid pump that forms a part of a lid body of a liquid container and pumps up a fixed amount of liquid from the inside of the container main body in response to push-down operation, and is provided with a stopper that limits the push-down amount of the push-down portion provided in a movable manner in a movement space of the pump push-down portion so that the movement amount is adjustable in a stepped manner between a maximum movement amount and an immobile position to measure and dispense a fixed amount corresponding to the push-down amount of the push-down portion,
the stopper is a projection projectedly provided on an inner wall of a pump head outer cylinder,
a cylindrical body which is to bee inserted inside the pump head is provided on a container lid body,
the cylindrical body is provided with a plurality of vertical grooves having different lengths, each of which is engageable with the projection to allow the projection to slide vertically, and
when the pump head is pushed down upon fitting the positions of the projection and desired one of the vertical grooves by rotating the pump head, the pump head is pushed down with a stroke limited according to the length of the vertical groove.

(29) In a pump with a function for measuring a fixed amount in a way that the amount to be discharged is adjusted in a stepped manner, which is a push-down liquid pump that forms a part of a lid body of a liquid container and pumps up a fixed amount of liquid from the inside of the container main body in response to push-down operation, and is provided with a stopper that limits the push-down amount of the push-down portion provided in a movable manner in a movement space of the pump push-down portion so that the movement amount is adjustable in a stepped manner between a maximum movement amount and an immobile position to measure and dispense a fixed amount corresponding to the push-down amount of the push-down portion,
the stopper is a projection projectedly provided on an outer wall of a pump head inner cylinder,
a cylindrical body which is to be inserted inside the pump head is provided on a container lid body,
the cylindrical body is provided with a plurality of vertical grooves having different lengths, each of which is engageable with the projection to allow the projection to slide vertically, and
when the pump head is pushed down upon fitting the positions of the projection and a desired vertical groove by rotating the pump head, the pump head is pushed down with a stroke limited according to the length of the vertical groove.

### BEST MODE FOR CARRYING OUT THE INVENTION

Hereinafter, embodiments of the pump with a function of measuring a fixed amount in a way that the discharge amount is adjustable (hereinafter, referred to as this pump) are described in detail.

### EMBODIMENT 1

FIG. 1 and FIG. 2 show Embodiment 1 of this pump. FIG. 1 is a front view of a liquid container 2 provided with this pump 1. A stopper 4 that limits the push-down amount of a pump head 3 is partially cut in the view. FIG. 2 is a central longitudinal sectional view.

As shown in FIG. 1 and FIG. 2, the liquid container 2 is provided with, as a lid body, the pump 1 integrated with a cap member 7 at an upper opening 6 of a bottle-shaped container main body 5. For the container main body 5, a soft resin material such as polypropylene is widely used, however, it can be formed from a hard resin or glass, etc., and the material is not limited and a container generally distributed can be selected as appropriate.

This pump 1 forms a part of the lid body of the liquid container 2, and uses a generally common structure of a push-down liquid pump for the function itself for discharging the contents of a container in which the pump feeds a fixed amount of liquid by pressure to a discharge opening 8 from the inside of the pump main body by a push-down operation and pumps up the liquid from the container main body 5 when it comes up, and the invention does not rely on this pump form. A cylinder 9 is provided with a flange portion 10 to be placed over an opening 6 of the container main body 5 at the upper end, and is shaped to narrow downward in a serial arrangement of cylindrical bodies with a plurality of diameters, and a suction tube 12 for suctioning the contents from the bottom of the container main body 5 is inserted into a tip end 11 of the cylinder 9. Inside the cylinder 9, a check ball 14 is provided so as to close the tube 13 with the smallest diameter at the lowest portion, and a spring 15 is inserted so as to press the check ball from above. On the spring 15, a piston 17 formed by winding a seal member 16 is placed. The piston 17 has a hollow connecting tube 18 extending upward from the upper end, and the pump head 3 is fitted at the tip end of the tube. The pump head 3 consists of an outer cylinder 19, an inner cylinder 20 and a discharge tube 21, and the connecting tube 18 is inserted into the inner cylinder 20. A cylindrical member 22 formed of a hollow member is inserted into the upper portion of the cylinder 9. This cylindrical member 22 has a barricade function for preventing water, etc., from entering the cylinder 9 from the upper surface of the lid body and a function as a piston rise stopper at the lower end, and in addition, performs a function as a guide for preventing wobble depending on the conditions when connecting tube 18 and the pump head 3 are pushed down.

The above-described check ball 14 functions as a check valve of the suction side when the piston 17 is moved up and down, and the seal member 16 of the piston 17 functions as a check valve of the discharge side. The spring 15 presses the check ball 14 downward and simultaneously functions as a return spring for pushing-back the piston 17 upward.

The pump main body 1 thus constructed has a flange portion 10 at the upper end of the cylinder 9 placed over the upper end of the opening 6 of the container main body 5, and is fixed by the cap member 7 together with the flange portion 10 of the cylindrical member 22 to the container main body 5 by means of a screw, not shown.

With this construction, by pushing-down the pump head 3 by hand, the check valve of the suction side is closed and the inner pressure inside the cylinder 9 under the piston 17 is increased, and the contents pass through the inside of the seal member 16, the inside of the connecting tube 18, and the inside of the pump head inner cylinder 20 and the inside of the discharge tube 21, and are discharged from the discharge opening 8. Then, when the pump head 3 is released from a hand, the pump head 3 is pushed back upward by the return spring 15, and at this point, the inner pressure inside the cylinder 9 under the piston 17 becomes negative, the seal member 16 of the piston 17 as a check valve of the discharge side closes, and the check ball 14 as a check valve of the suction side rises against the spring force, and from a gap created accordingly, the contents of the container flow into the cylinder 9. Then, for the next pushing down of the pump head 3, the contents are filled in the cylinder 9. When the contents are filled in the cylinder 9, the check ball 14 becomes unable to resist the pressing force of the return spring 15 and closes the suction port again.

This container contents discharge method of the pump 1 mentioned above is one example, and any pump structure can be employed as long as a piston is provided in the cylinder, two check valves are provided so as to sandwich the piston, and the contents flow in the direction of the piston reciprocation in principle.

In this pump 1, a male screw 24 is provided on the outer circumference near the lower end of the pump head 3, and a cylindrical stopper 4 is concentrically provided which has a female screw 25 to be screwed with the male screw on the inner circumference. By rotating the stopper 4, the entire length H of the pump head 3 becomes extensible downward, and as shown in FIG. 3(b), the lower end 26 of the stopper 4 is positioned within a range between the lower end 27 of the pump head 3 and the upper surface 28 of the cap member 7 against which the lower end 27 butts when the pump head 3 is pushed down, whereby the push-down amount L is set in a stepless manner. Then, when the pump head 3 is pushed down, the lower end 26 of the stopper 4 butts against the upper surface 28 of the cap member 7 to limit pushing-down. The discharge amount can be freely set in a stepless manner in a range from one drop to the maximum discharge amount. In the case of the maximum discharge amount, the lower end 27 of the pump head 3 may butt against the upper surface. In FIG. 1, the reference numeral 29 denotes graduations.

As the screw used herein, a square screw is employed in all embodiments of the pump 1, however, a triangle screw may be used, and any type of screw can be used as long as the screw rotates smoothly and has high accuracy without play.

To use the pump 1 of this embodiment, after the upper end 30 of the stopper 4 is adjusted to a graduation 29 marked on the pump head 3 by rotating the stopper 4 while the piston head 3 is held and fixed by hand, the pump head 3 is pushed down until the lower surface 26 of the piston 4 butts against the upper surface 28 of the cap member 7 (the push-down amount L).

FIG. 3(a) shows a condition where the stopper 4 is set at the pump head fixing position, and FIG. 3(b) shows a condition where the stopper 4 is set at the maximum discharge amount position.

As mentioned above, in this embodiment, only machining of the pump head 3 easily enables application to a conventional type of pump. As a formation of the stopper 4, as shown in FIGS. 1 through 3, either the simple cylindrical body provided with a female screw on the inner diameter or a formation having a bottom portion flat surface penetrated by the connecting tube 18 can be employed.

Furthermore, as shown in FIG. 4, it is also possible that a cylindrical portion 31 with a diameter that enables it to cover the cap member 7 is formed at the lower portion of the stopper 4. In this case, the movement amount L of the pump head 3 is limited by butting of the lower end of the cylindrical portion extended from the pump head 3 (the lower surface 33 of the flat portion 32 that connects the cylindrical portions with two diameters different from each other in FIG. 4) against the upper surface 28 of the cap member 7. In this embodiment, graduations 29 are marked on the side surface of the cap member 7.

To use the pump 1 in this case, after the lower end 26 of the-stopper 4 is set to a graduation 29 marked on the cap member 7 by rotating the stopper 4, the pump head 3 is pushed down until the lower surface 33 of the flat portion 32 of the stopper butts against the upper surface 28 of the cap member 7 (the push-down amount L).

### EMBODIMENT 2

FIG. 5 through FIG. 9 show Embodiment 2 of this pump, wherein FIG. 5 is a main part front view when the stopper 4 is set at the maximum discharge amount position, FIG. 6(a) is a partially longitudinal sectional view of the pump head 3 in this case, and FIG. 6(b) is a partially longitudinal sectional view of the piston head 3 when the stopper 4 is set at the piston head fixing position.

As shown in FIG. 5 and FIG. 6, in this embodiment, a stopper 4 is attached inside the pump head 3. The pump head 3 has a female screw 25 formed on the lower portion inner circumference of the outer cylinder 19. The connecting tube 18 is inserted into the inner cylinder 20. The stopper 4 having a male screw 24 to be screwed with the female screw 25 is housed inside the pump head 3. The stopper 4 is provided with a flange portion 10 at the lower end of a cylindrical body having a male screw 24 on the outer circumference, and the flange portion is used as a knob for discharge amount adjustments. The push-down amount L is set in a stepless manner by positioning the lower end 26 of the stopper 4 within a range between the lower end 27 of the pump head 3 and the upper surface 28 of the cap member 7. In FIG. 5, the graduations 29 are marked on the pump head 3 and the index 36 is marked on the side surface of the flange portion 10 of the stopper 4, and marking in reverse is also possible as a matter of course.

As shown in FIG. 7, it is also possible that the outer edge of the flange portion 10 is raised upward to form a cup-shaped longitudinal section so that the inner side and outer side sandwich and cover the lower portion of the pump head 3. In this case, the graduations 29 can be marked on the side surface of the pump head 3 in the same manner as in the above-described Embodiment 1.

In the case of FIG. 8, the flange portion 10 is provided with a projection 37 for finger hooking on the outer circumference as shown in FIG. 8(a), or as shown in FIG. 8(b), a polygonal shape is employed for making finger hooking easier for rotation. Furthermore, the upper cylindrical portion of the cylindrical member 22 is not provided in some cases, and in these cases, a through hole 38 which the connecting tube 18 penetrates may be made in the flange portion 10 as shown in FIG. 9.

To use the pump 1 of this embodiment, the flange portion 10 is pinched with fingers and the stopper 4 is rotated while the piston head 3 is held and fixed by hand, and the index 36 is set to a graduation 29 marked on the piston head 3, and thereafter, the pump head 3 is pushed down until the lower end 26 of the stopper 4 butts against the upper surface 28 of the cap member 7 (the push-down amount L).

### EMBODIMENT 3

FIG. 10 show Embodiment 3 of this pump, wherein (a) shows a condition where a stopper 4 is set at a pump head fixing position and (b) shows a condition-where the stopper is set at a maximum discharge amount position.

In this embodiment, a male screw 24 is formed on the outer circumference of a connecting tube 18, and a stopper 4 is used which has a female screw 25 to be screwed with the male screw 24 of the connecting tube 18 on its inner diameter and a flat portion 32 on the upper surface. In FIG. 10, a cylindrical portion 31 is provided at the outer edge of the flat portion 32 so as to cover the cap member 6, and graduations 29 are marked on the cap member 7. The push-down amount L is set in a stepless manner by positioning the flat portion 32 of the stopper 4 in a range between the lower end 27 of the pump head 3 and the upper surface 28 of the cap member 7.

In this embodiment, it is necessary that engagement between the inner cylinder 20 of the piston head 3 and the connecting tube 18 is contrived to prevent mutual rotation of the pump head 3 and the connecting tube 18. For example, it is preferable that the cross sectional shape of the upper end fitting portion between the inner cylinder 20 and the connecting tube 18 is formed to be polygonal.

To use the pump 1 of this embodiment, the lower end 26 of the piston head 3 is set to a graduation 29 marked on the cap member 7 by rotating the stopper 4 while the piston head 3 is held and fixed by hand, and thereafter, the pump head 3 is pushed down until the lower surface 33 of the flat portion 32 of the stopper 4 butts against the upper surface 28 of the cap member 7 (the push-down amount L).

In this case, the screw portion of the stopper may be provided higher than the flat portion 32.

As shown in Embodiments 1 through 3above, in the adjusting mechanism of the push-down amount limiting means of the pump head 3, positioning is adjustable in a stepless manner by screwing the pump head 3 as a fixed part and the stopper 4 as a movable part together. The dimensions of the screws are designed at a proper tightening degree that does not result in hard rotation and prevents the stopper 4 from easily rotating when the pump head 3 moves.

### EMBODIMENT 4

FIG. 11 show Embodiment 4 of this pump 1, wherein (a) is a partially cut main part front view and (b) is a sectional view along A-A. In FIG. 11, the cylindrical member 22 is omitted.

In the above-described embodiments, stepless adjustments from the fixing position to the maximum discharge amount position are realized by screwing, however, in this embodiment, in respect to adjustments, a construction that gives a moderate feeling to the rotation of the stopper 4 is employed. As shown in FIG. 11, the peak portions 39 of screw threads formed on the outer circumference of the pump head 3 are divided equally throughout substantially the entire region of the threads, and notches 40 are formed at the divided points as engageable portions. Near the female screw portion 25 of the stopper 4, a ball 41 is provided as an engaging means that engages with the engageable portions 40, and is pressed against the screw thread peak portion 39 by a spring 42 as an elastic member. When the stopper 4 is rotated, a moderate feeling is given to the rotation of the stopper 4 by engaging this ball 41 in the above-described notches 40. In order to secure a more preferable moderate feeling and accuracy, the spherical surface of the ball 41 and the dimensions of the notches 40 are determined so as not to have undesirable play. Thereby, improved usability with clicking sounds is realized, and this manner can be used as means suitable for a case where an amount to be measured is arbitrarily set in advance not at a level of completely stepless adjustment. Therefore, it can also be employed in the following embodiments in the case of stepless adjustment using screws as means for adjusting the stopper.

### EMBODIMENT 5

FIG. 12 through FIG. 14 show Embodiment 5 of this pump, and in FIG. 12, (a) is a main part front view and (b) is a central longitudinal sectional view of the same. A stopper 4 is attached inside the pump head 3 in the same manner as in the above-described Embodiment 2. The stopper 4 has a comb-shaped groove 43, and in the pump head 3, a projection 44 to be engaged with this groove 43 is provided inside the outer cylinder 19 so as to face inward. The comb-shaped groove 43 has fitting portions 45 which are fitted with the projection 44 and arranged in parallel in the lengthwise direction of the stopper 4 as shown in FIG. 13, and further has a connecting groove 46 that connects these fitting portions 45. The projection 44 is slid inside this connecting groove 46 and made to fit a fitting portion 45 at a desired position. By forming the fitting portion 45 so that the width near the entrance of the fitting portion 45 is slightly narrowed and the projection 44 is pressed into the fitting portion 45, the projection 44 becomes hard to slip out of the fitting portion 45, a moderate feeling is obtained, and it becomes easier to use.

FIG. 14 show working of this pump in this embodiment. In FIG. 14, (a) shows a fixed condition of the pump head 3 while the stopper 4 is lowered to the lowest, and (b), (c), and (d) show discharge conditions, respectively. (d) shows a condition where the stopper 4 is set to the maximum discharge amount. The size of the drop in the figures schematically represents the amount of discharge.

To use this pump 1 of this embodiment, the projection 44 is positioned so as to freely slide in the connecting groove 46 by rotating the stopper 4 while the piston head 3 is held and fixed by hand, and the amount of projection of the stopper 4 from the pump head 3 is selected and the projection is set at a position of fitting with the projection fitting portion 45, and then the stopper 4 is rotated to press and fix the projection 44 into the fitting portion 45. Thereafter, the pump head 3 is pushed down. The pump head 3 is pushed down until the lower end 26 of the stopper 4 butts against the upper surface 28 of the cap member 7 (the push-down amount L) to discharge the contents.

By providing two pairs of comb-shaped grooves 43 and projections 44 opposite each other, the latching condition of the stopper 4 is stabilized.

Regarding the comb-shaped groove 43 and the projection 44, the projection 44 is provided on the piston head 3 and the comb-shaped groove 43 is provided in the stopper 4 in the above description, however, to the contrary, as a matter of course, it is possible that the comb-shaped groove 43 is provided in the piston head 3 and the projection 44 is provided on the stopper 4.

Furthermore, it is possible that the comb-shaped groove 43 penetrates the thickness at the groove forming portion, or the thickness is left, that is, the groove has a bottom. The latter case is preferable in the case where high rigidity of the member must be maintained.

Furthermore, as shown in FIG. 15 and FIG. 16, it is also possible that, different from the above description, the stopper 4 is formed cylindrically so that the stopper 4 envelopes the pump head 3 and the outer cylinder 19 of the pump head 3 is inserted inside the stopper. In FIG. 15, (a) is a main part front view and (b) is a central longitudinal sectional view. The comb-shaped groove 43 is formed in the outer circumference of the pump head 3, and the projection 44 to engage with this groove 43 is provided on the inner circumference of the stopper 4 so as to face inward.

### EMBODIMENT 6

FIG. 17 through FIG. 19 show Embodiment 6 of this pump, and in FIG. 17, (a) is a main part front view and (b) is a central longitudinal sectional view of the same. The stopper 4 is a cylindrical body enveloping the connecting tube 18, the connecting tube 18 slides inside the stopper 4 and the upper cylindrical portion is inserted into the pump head 3, and the lower portion is provided with a large-diameter cylindrical portion 31 via a flat portion 32 so as to cover the cap member 7. The comb-shaped groove 43 is provided in the upper cylindrical portion of the stopper 4, and the projection 44 to be engaged with this groove 43 is provided on the upper outer circumference of the connecting tube 18. The comb-shaped groove 43 shown in FIG. 18 is formed in the same manner as in the above-described Embodiment 5.

FIG. 19 show working of this pump of this embodiment. In the figures, (a) shows the fixed condition of the pump head 3 while the stopper 4 is lowered to the lowest, and (b), (c), and (d) show discharge conditions, respectively. (d) shows a condition where the stopper 4 is set to the maximum discharge amount.

To use this pump 1 of this embodiment, the projection 44 is set so as to freely slide inside the connecting groove 46 by rotating the stopper 4 while the piston head 3 is held and fixed by hand, the amount of projection of the upper cylindrical portion of the stopper 4 from the pump head 3 is selected and the projection is set at a position to fit the projection fitting portion 45, and thereafter, the stopper 4 is rotated to press and fix the projection 44 into the fitting portion 45. Then, the pump head 3 is pushed down until the lower surface 33 of the flat portion 32 of the stopper 4 butts against the upper surface 28 of the cap member 7 (the push-down amount L) to discharge the contents.

FIG. 20 and FIG. 21 show another construction example of the comb-shaped groove 43 applicable to the above-described Embodiments 4 through 6. In this case, the comb-shaped groove 43 is formed diagonally. The comb-shaped groove 43 has fitting portions 45 which the projection 44 fits and are arranged in parallel while gradually shifting their positions diagonally as shown in FIG. 20, and further has a connecting groove 46 that connects these fitting portions 45. The projection 44 is slid inside the connecting groove 46 and made to fit a fitting portion 45 at a desired position. By forming the fitting portion 45 so that the width near the entrance of the fitting portion 45 is slightly narrowed and the projection 44 is pressed into the fitting portion 45, the projection 44 becomes hard to slip out of the fitting portion 45, a moderate feeling is obtained, and it becomes easier to use.

FIG. 21 show an application example thereof. In these figures, (a) shows a case where the comb-shaped groove 43 is formed in the outer circumference of the piston head 3 and the projection 44 is provided on the inner circumference of the stopper 4, and (b) shows the reverse case where the projection 44 is provided on the outer circumference of the piston head 3 and the comb-shaped groove 43 is formed in the inner circumference of the stopper 4.

### EMBODIMENT 7

FIG. 22 through FIG. 24 show Embodiment 7 of this pump, and in FIG. 22, (a) shows a fixed condition of the pump head 3 into which the stopper 4 is fitted, and (b) is a perspective view of the stopper 4. At the lower end of the piston head 3, a projecting thread 47 is formed across almost the entire circumference. The stopper 4 is U-shaped, and on its inner surface, thread grooves 48 to be engaged with the projecting thread 47 are formed in parallel so that this stopper 4 is attachable to and detachable from the piston head 3. At the lower end, a rib 49 for increasing the rigidity of the stopper 4 is preferably provided. As shown in FIG. 23, this stopper 4 is attached from the side so that the projecting thread 47 engages with the thread groove 48. FIG. 23 are views of the stopper 4 from the front side, wherein (a) shows a condition where the stopper 4 is set to obtain a fixed condition of the pump head 3, and (b) shows a condition where the stopper 4 is set to the maximum discharge amount.

In thread grooves 48 of the stopper 4, protruded portions 50 are preferably provided at desired positions of the ridges at relative positions. This narrows the opening width W of the stopper 4, more securely fits the stopper 4 with the pump head 3 so as not to easily slip out of the fitting portion, and gives a moderate feeling when the stopper 4 is attached.

To use the pump 1 of this embodiment, as shown in FIG. 24, the stopper 4 is attached-by fitting a desired thread groove 48 of the stopper 4 with the projecting thread 47 of the pump head 3, and the pump head 3 is pushed down until the lower end 26 of the stopper 4 butts against the upper surface 28 of the cap member 7 (the push-down amount L) to discharge the contents.

In this case, as a matter of course, it is also possible that the projecting thread 47 is formed on the stopper 4 side and the thread grooves 48 are formed on the piston 3 side.

### EMBODIMENT 8

FIG. 25 through FIG. 29 show Embodiment 8 of this pump, and in FIG. 25, (a) shows a condition where the stopper 4 is fitted, and (b) shows a central longitudinal sectional view of the same. In comparison with the above-described embodiments in which the push-down amount is adjusted by expanding and contracting the height of the pump head 3 by changing the position of the lower end 26 of the pump head 3, in this embodiment, the entering amount of the connecting tube 18 into the pump cylinder 9 is limited to limit the push-down amount of the pump. As shown in FIG. 25, the connecting tube 18 is provided with a plurality of thread grooves 48 formed in parallel on the entire circumference to be fitted with a plate-shaped stopper 4. FIG. 26 are sectional views along B-B of FIG. 25(a). The stopper 4 is shaped into a plate as shown in FIG. 25 and FIG. 26, and partially opens at the central portion so as to have almost a C-shape including a notch that fits the bottom portion 51 of the thread grooves 48. The knob 52 is used for attachment and detachment. The opening 53 is preferably formed so that the opening width is slightly narrowed so as to prevent the stopper 4 from easily coming out the thread groove 48.

FIG. 27 show working of the pump in this embodiment. In the figures, (a) shows a fixed condition of the pump head 3 while the stopper 4 is set at the lowest position, and (b), (c), and (d) show discharge conditions, respectively. (d) shows a condition where the stopper 4 is set to the maximum discharge amount.

To use the pump 1 of this embodiment, the stopper 4 is inserted into a desired thread groove 48 of the connecting tube 18, and the pump head is pushed down until the lower end 26 of the stopper 4 butts against the upper surface 28 of the cap member 7 (the push-down amount L) to discharge the contents.

FIG. 28 and FIG. 29 show another form of the stopper 4. FIG. 28 shows a stopper formed of an elliptic elastic body, and as shown in (a), the stopper is latched while sandwiching the bottom portion 51 of the thread grooves 48 in the short-diameter portion of the ellipse. Then, as shown in FIG. 28(b), the stopper is elastically deformed when the long-diameter portion is pressed by fingers, whereby the diameter of the short-diameter portion expands more than the diameter of the connecting tube 18 and the stopper becomes movable. Then, when the stopper is moved to another thread groove 48 and the pressing force applied to the long-diameter portion is released, the short-diameter portion narrows and sandwiches the bottom portion 51 of the thread groove 48 again.

FIG. 29 show a pinch type stopper. Lever portions 55 are formed and extend from the ends on one side of the pinching portions 54, and the pinching portions 54 pinch the bottom portion 51 of the thread grooves 48 by means of a spring that is not shown. When the lever portions 55 are pinched by fingers, the pinching portions 54 open in a seesaw manner, so that the position of the thread groove 48 can be freely changed.

As shown in the above-described Embodiments 4 through 8, the movement amount from the fixed position to the maximum amount discharge position of the pump head 3 is arbitrarily divided, and the discharge amount is set in advance, whereby simple mechanical operation for selection of a necessary amount is enabled by only setting the projection 44 to a pre-set latching position.

All the above-described embodiments have this working effect of the invention and need only a minimum number of parts to be added, so that the maximum working effect can be obtained without a remarkable increase in cost in comparison with the conventional pumps.

### EMBODIMENT 9

FIG. 30 show Embodiment 9 of this pump. In this embodiment, as stopper engaging means, engaging holes 56 and a projection 57 that fits the engaging holes are employed. As shown in this case, a plurality of engaging holes 56 are made at the fixation side in parallel to each other, and the projection 57 is provided on the stopper 4. (a) shows a condition where the engaging holes 56 are made in the connecting tube 18, and (b) shows a condition where the stopper 4 is fixed by fitting the projection 57 with the engaging hole 56. The projection 57 is preferably pressed so as to be pushed out toward the center of the stopper 4, however, it is also possible that a sliding method is employed by providing a lock mechanism. This mechanism is applicable to all the above-described embodiments.

### EMBODIMENT 10

FIG. 31 and FIG. 32 show Embodiment 10 of this pump, and in FIG. 31, (a) is a main part front view, and (b) is a central longitudinal sectional view of the same. The vicinity of the stopper 4 that limits the push-down amount of the pump head 3 is partially cut in the views.

In this pump 1, a male screw 24 is formed on the upper half outer circumference of the cylindrical member 19. Then, a stopper 4 that is provided with a female screw 25 to be screwed with the male screw 24 at the center portion and formed of a short cylindrical member having a flat top portion 32 is provided so as to cover the cap member 7.

The stopper 4 is freely movable in the lengthwise direction of the cylindrical member 22 in the distance L between the lower end 27 of the pump head 3 and the upper surface 28 of the cap member 7 by rotating the stopper itself in a screwing manner by using the cylindrical member 22 as a rotation shaft. Namely, when the pump head 3 is pushed down, it is allowed to move by a movement amount as the push-down amount L until the lower end 27 butts against the upper surface 32 of the stopper 4 provided on a fixing member to be fixed to a container main body which does not lower (move) together with the pump head 3.

FIGS. 32(a) through 32(d) show different positions of the stopper 4, respectively. As shown in (a), when the stopper 4 is positioned highest, the lower end 27 of the pump head 3 butts against the upper surface 32 and this makes the piston unable to lower, and the piston is fixed.

This pump 1 constructed as described above is used as shown in the respective figures of FIG. 32. First, as shown in (a), by positioning the stopper 4 highest, the push-down amount of the pump head 3 becomes zero and the pump head can be fixed. Therefore, it becomes possible to, not to mention, not only fix the pump head during distribution, but also fix the pump head in the condition as it is without wasteful discharge of the contents filled in the cylinder 9 even during use.

To discharge, as shown in (b) though (d), the stopper 4 is rotated so as to set the lower end 26 of the stopper 4 to the graduation 29 marked on the side surface of the cap member 7, and thereafter, the pump head 3 is pushed down by hand until the lower end 27 of the pump head butts against the upper surface 32 of the stopper 4, whereby a desired amount of the contents is accurately measured and discharged from the discharge opening 8. In FIG. 32, (d) shows a condition where the stopper 4 is set at the position of the maximum discharge amount.

### EMBODIMENT 11

FIG. 33 show Embodiment 11 of this pump, wherein (a) shows a condition where the stopper 4 is set at the pump head fixing position, and (b) shows a condition where the stopper 4 is set at the position of the maximum discharge amount. In this embodiment, the construction of the notches 40 and the ball 41 of the above-described Embodiment 4 (FIG. 11) is applied to the construction of the above-described Embodiment 10, and the working effect thereof is the same as in the above-described Embodiment 11.

### EMBODIMENT 12

FIG. 34 show Embodiment 12 of this pump, wherein (a) shows a condition where the stopper 4 is set at the pump head fixing position, and (b) shows a condition where the stopper 4 is set at the maximum discharge amount position.

In this embodiment, a male screw 24 is formed on the outer circumference of the cap member 7, and a stopper 4 is formed into a cap shape that has a female screw 25 to be screwed with the male screw 24 of the cap member 7 on the inner diameter and has a flat portion 32 at the upper side so as to cover the cap member 7. The push-down amount L is set in a stepless manner by positioning the flat portion 32 of the stopper 4 in a range from the lower end 27 of the pump head 3 to the upper surface 28 of the cap member 7. Then, the lower end 26 of the pump head 3 butts against the top portion 25 of the stopper 4 to limit its movement amount.

### EMBODIMENT 13

FIG. 35 show Embodiment 13 of this pump, wherein (a) shows a condition where the stopper 4 is set at the pump head fixing position, and (b) shows a condition where the stopper 4 is set at the maximum discharge amount position.

In this embodiment, a female screw 25 is formed on the inner circumference of the cylindrical member 22, and the stopper 4 employed has a cylindrical portion 60 having a male screw 24 to be screwed with, the female screw 25 of this cylindrical member 22 on the outer diameter and has a cup-shaped portion 61 enveloping the lower portion of the pump head 3 above the cylindrical portion. The push-down amount L is set in a stepless manner by positioning the bottom portion 62 of the cup-shaped portion 61 of the stopper 4 within a range between the lower end 27 of the pump head 3 and the upper surface 32 of the cap member 7.

It is possible as a matter of course that the upper portion shape of the stopper 4 has, instead of the cup shape, only a bottom portion 62 which the lower end 27 of the pump head 3 butts against.

### EMBODIMENT 14

FIG. 36 and FIG. 37 show Embodiment 14 of this pump. In FIG. 36, (a) shows a condition where the stopper 4 is set at the pump head fixing position, and (b) shows a condition where the stopper 4 is set at the maximum discharge amount position.

In this embodiment also, as in the above-described Embodiment 13, a female screw 25 is formed on the inner circumference of the cylindrical member 22, and the stopper 4 used has, on its outer diameter, a male screw 24 to be screwed with the female screw 25 of the cylindrical member 22. As a matter of course, it is also possible that the female screw 25 is provided on the cap member 7.

In FIG. 37, (a) is a plan view of the stopper 4, and (b) is a cross sectional view of the connecting tube 18. On the inner diameter of the stopper 4, a plurality (four in FIG. 37) of projecting threads 47 are formed in the lengthwise direction, and on the outer circumference of the connecting tube 18, thread grooves 48 that fit the projecting threads 47 are formed. Of course, provision in reverse is also possible. The stopper 4 slides up and down on the outer circumference of the connecting tube 18 while these projecting threads 47 and thread grooves 48 function as a rotation stopper and tracks. Then, as shown in FIG. 38(a), when the stopper is screwed with the female screw 25 formed on the cylindrical member 22 (or cap member 7), the pump head 3 is rotated and the connecting tube 18 also rotates together, and the stopper 4 accompanies the rotation due to the projecting threads 47 and the thread grooves 48 and rotates. Then, the stopper 4 becomes able to freely come out from and go down below the upper surface 28 of the cap member 7. Namely, the discharge amount can be freely set in a range from one drop to the maximum discharge amount by the amount of rotation of the pump head 3. As measuring standards for the discharge amount, graduations 29 are preferably marked on the connecting tube 18.

To use the pump 1 of this embodiment, the pump head 3 is rotated without touch on the stopper 4, and after a graduation 29 on the connecting tube 18 is set to the upper end 30 of the stopper 4, the pump head 3 is pushed down until the lower end 27 of the pump head butts against the upper end 30 of the stopper 4.

### EMBODIMENT 15

FIG. 38 and FIG. 39 show Embodiment 15 of this pump, and in FIG. 38, (a) shows a condition where the stopper 4 is fitted, and (b) shows a central longitudinal sectional view of the same. As-shown in FIG. 38, the cylindrical member 22 is provided with a plurality of thread grooves 48 formed in parallel across the entire circumference to be fitted with the plate-shaped stopper 4. A sectional view along D-D of FIG. 38(a) is almost similar to the above-described FIG. 26.

FIG. 39 show working of this pump in this embodiment. In the figures, (a) shows a fixed condition of the pump head 3 while the stopper 4 is set at the highest position, and (b), (c), and (d) show discharge conditions, respectively. (d) shows a condition where the stopper 4 is set to the maximum discharge amount.

To use the pump 1 of this embodiment, the stopper 4 is inserted into a desired thread groove 48 of the cylindrical member 22, and the pump head 3 is pushed down until the lower end 27 of the pump head 3 butts against the upper surface 32 of the stopper 4 (the push-down amount L) to discharge the contents.

As other forms of the stopper 4, the stoppers 4 shown in the above-described FIG. 28 and FIG. 29 can be used in this case also. Furthermore, as shown in FIG. 40, it is also possible that the stopper 4 is formed so as to cover the cap member 7 and graduations are marked on the cap member 7.

The stopper shown in the above-described FIG. 30 can be used in this case also.

### EMBODIMENT 16

FIG. 41 through FIG. 43 show Embodiment 16 of this pump, wherein FIG. 41 shows a condition of fitting the stopper 4. On the side surface of the cap member 7, a plurality of projecting threads 47 are formed in parallel across almost the entire circumference. The stopper 4 is U-shaped, and in its inner surface, a thread groove 48 that engages with the projecting threads 47 is formed so that the stopper 4 can be detachably attached to the cap member 7. At the upper end of the stopper 4, a rib 49 for increasing the rigidity of the stopper 4 is preferably provided. As shown in FIG. 41, this stopper 4 is fitted from the side so that the projecting thread 47 and the thread groove 48 engage with each other. FIG. 42 show a condition where the stopper 4 is set to fix the pump head 3, wherein (a) is a view from the side of the stopper 4 and (b) is a view from the front of the stopper 4.

To use the pump 1 of this embodiment, the stopper 4 is fitted by fitting the thread groove 48 of the stopper 4 with a desired projecting thread 47 of the cap member 7, and the pump head 3 is pushed down until the lower end 27 of the pump head 3 butts against the upper surface 32 of the stopper 4 (the push-down amount L) to discharge the contents.

In this case, as shown in FIG. 43, it is also possible that the number of the projecting threads 47 of the cap member 7 side is small and the number of the thread grooves 48 of the stopper 4 side is plural. Of course, it is also possible that the projecting threads 47 are formed on the stopper 4 side and the thread groove 48 is formed on the cap member 7 side.

### EMBODIMENT 17

FIG. 44 through FIG. 46 show Embodiment 17 of this pump, and in FIG. 44, (a) is a main part front view and (b) is a central longitudinal sectional view of the same. The stopper 4 is provided with a comb-shaped groove 43, and a projection 44 that engages with this groove 43 is provided on the upper outside of the cylindrical member 22. The construction of the comb-shaped groove 43 and the projection 44 is the same as in the above-described Embodiment 5. In the figures, the lower portion of the stopper 4 is formed into a cap shape so as to cover the cap member 7, however, it is not necessarily formed into a cap shape, and it is also possible that the lower end of the stopper is flat.

FIG. 46 show working of this pump in this embodiment. In the figures, (a) shows a fixed condition of the pump head 3 while the stopper 4 is raised highest, and (b), (c), and (d) show discharge conditions, respectively. (d) shows a condition where the stopper 4 is set to the maximum discharge amount.

To use this pump 1 of this embodiment, the projection 44 is positioned so as to be able to freely slide in the connecting groove 46 by rotating the stopper 4, the distance L from the upper surface 32 of the stopper 4 to the lower end 27 of the pump head 3 is selected and the projection 44 is set to a position of fitting with a fitting groove 45, and thereafter, the stopper 4 is rotated to press and fix the projection into the fitting groove 45. Then, the pump head 3 is pushed down until the lower end 27 of the pump head 3 butts against the upper surface 32 of the stopper 4 (the push-down amount L) to discharge the contents.

### EMBODIMENT 18

FIG. 47 through FIG. 49 show Embodiment 18 of this pump, and in FIG. 47, (a) is a main part front view, and (b) is a central longitudinal sectional view of the same. This embodiment also has the same construction of the comb-shaped groove 43 and the projection 44 between the stopper 4 and the cap member 7 as in the above-described Embodiment 5. In FIG. 48, the through hole 38 is penetrated by the cylindrical member 19.

FIG. 49 show working of this pump in this embodiment. In FIG. 49, (a) shows a fixed condition of the pump head 3 while the stopper 4 is raised highest, and (b), (c), and (d) show discharge conditions, respectively. (d) shows a condition where the stopper 4 is set to the maximum discharge amount.

To use the pump 1 of this embodiment, in the same manner as in the above-described Embodiment 5, the projection 44 is set to the position of a desired fitting groove 45, and the pump head 3 is pushed down until the lower end 27 of the pump head 3 butts against the upper surface 32 of the stopper 4 (the push-down amount L) to discharge the contents.

### EMBODIMENT 19

FIG. 50 through FIG. 52 show Embodiment 19 of this pump, and in FIG. 50, (a) is a main part front view and (b) is a central longitudinal sectional view of the same. The stopper 4 has a cylindrical lower portion and an upper portion formed into a cap shape so as to envelope the lower portion of the pump head 3. The cylindrical portion of the stopper receives insertion of the connecting tube 18, and the cylindrical portion itself is inserted into the cylindrical member 22 and provided with a comb-shaped groove 43. In this embodiment, the cylindrical member 22 has no rising portions at the upper side and its upper end ends at the flange portion 10. FIG. 51(a) is a cross sectional view along E-E of FIG. 50(a). At the center of the upper surface 28 of the cap member, a through hole 38 is made, and a projection 44 that engages with the comb-shaped groove 43 is projectedly formed on the inner circumference.

FIG. 52 show working of this pump in this embodiment. In the figures, (a) shows a fixed condition of the pump head 3 while the stopper 4 is raised highest, and (b), (c), and (d) show discharge conditions, respectively. (d) shows a condition where the stopper 4 is set to the maximum discharge amount.

To use this pump of this embodiment also, the pump head 3 is pushed down upon setting the projection 44 to the position of a desired fitting groove 45.

FIG. 53 and FIG. 54 show another construction example of the above-described comb-shaped groove 43. In this case, the comb-shaped groove 43 is formed diagonally. The comb-shaped groove 43 has fitting grooves 45 that are fitted with the projection 44 and are formed by gradually shifting their positions diagonally in parallel as shown in FIG. 53, and further has a connecting groove 46 that connects these fitting grooves 45. The projection 44 is slid inside this connecting-groove 46 and made to fit the fitting groove 45 at a desired position.

FIG. 54 shows an application example of this construction. In this case, either way is possible that the comb-shaped groove 43 is formed in the outer circumference of the cap member 7 and the projection 44 is formed on the inner circumference of the stopper 4, or the projection 44 is formed on the outer circumference of the cap member 7 and the comb-shaped groove 43 is formed in the inner circumference of the stopper 4.

As described above, the movement amount from the fixed position to the maximum amount discharge position of the pump head 3 is arbitrarily divided and the discharge amount is set in advance, whereby simple mechanical operation for selection of a necessary amount is enabled by only setting the stopper 4 to a pre-set latching position.

### EMBODIMENT 20

FIG. 55 and FIG. 56 show Embodiment 20 of this pump, and in FIG. 55, (a) is a main part front view, and (b) is a central longitudinal sectional view of the same.

In this pump, a projection 44 is formed on the outer circumference of a cylindrical upper portion 74 formed above the flange portion 10 of the cylindrical member 22. A plurality (three in FIG. 57) of vertical grooves 70 that have different lengths and engage with this projection 44 are formed in the outer cylinder 19 of the pump head 3, and these form a stopper in conjunction with the projection 44. The pump head 3 is freely rotatable, so that one vertical groove 70 can be arbitrarily set at a position of engagement with the projection 44. The distance L until the upper end of the projection 44 butts against the upper end 71 of the vertical groove 70 is the piston push-down amount. In FIG. 55, since three vertical grooves are formed, the discharge amount can be adjusted in three steps.

Furthermore, it is as a matter of course that either way is possible that the vertical grooves 70 can be formed into slits penetrating the thickness of the outer cylinder 19 of the pump head 3 as shown in FIG. 55, or the thickness of the outer cylinder 19 is increased and the vertical grooves 70 are formed to have a depth in the inner wall of the outer cylinder 19 so as not to be exposed to the outside. The number of the vertical grooves 70 can be set only to an extent that the rigidity of this outer cylinder 19 is not significantly lowered. Namely, at the position at which the lower end 27 of the pump head 3 is in contact with the projection 44, lowering of the piston 3 is limited, and the maximum discharge amount is obtained in a condition where the piston is pushed down to a position at which the lower end 27 comes into contact with the upper end 28 of the cap member 7, so that in the range of this movement, the vertical grooves 70 are properly arranged according to intended discharge amounts.

The pump constructed as mentioned above is used as shown in FIGS. 56(a) through 56(d). First, as shown in (a), the pump head 3 can be fixed at the highest position, so that the pump head can be fixed as it is during the distribution process and even during use without wasteful discharge of the contents filled in the cylinder 9.

As to discharge, as shown in (b) through (d), the pump head 3 is rotated to set the projection 44 and a desired vertical groove 70 at an engagement position, and thereafter, the pump head 3 is pushed down by hand until the upper end of the projection 44 butts against the upper end 71 of the vertical groove 70, whereby a desired amount of the contents is accurately measured and discharged from the discharge opening 8. In FIG. 56, (d) shows a condition where the stopper is set at the position of the maximum discharge amount. In this pump, even when the pump head 3 rotates during pushing-down, the stop position is prevented from being displaced like slippage off steps since the projection 44 uses the vertical groove 70 as a sliding guide, and therefore, it becomes possible that a set discharge amount is extremely stably and accurately measured and discharged.

### EMBODIMENT 21

FIG. 57 show Embodiment 21 of the pump of this invention, wherein (a) is a main part front view of a liquid container with this pump 1, and (b) is a main part longitudinal sectional view of the same.

In this pump 1, a cylindrical member 72 with a diameter larger than that of the pump head 3 is provided above the cap member 7 so as to allow insertion of the pump head 3. These members may be united together. On the outer circumference near the lower end of the pump head 3, a projection 44 is formed. A plurality (three in FIG. 57) of vertical grooves 70 that engage with the projection 44 and have different lengths are formed in the cylindrical member 72, and these form a stopper in conjunction with the projection 44. In this case, the cylindrical member 22 standing up from the cylinder 9 may not have the cylindrical portion 74 above the flange portion 10.

To use this pump 1 constructed as mentioned above, as shown in FIG. 58, in the same manner as in the above-described Embodiment 20, the pump head 3 is rotated to set the projection 44 and a desired vertical groove 70 at an engagement position, and then, the pump head 3 is pushed down by hand until the lower end of the projection 44 butts against the lower end 73 of the vertical groove 70.

### EMBODIMENT 22

FIG. 59 show Embodiment 22 of the pump of this invention, wherein (a) is a main part front view of a liquid container with this pump 1, and (b) is a main part longitudinal sectional view of the same.

In this pump 1, the construction of the grooves and the projection is the same as in the above-described Embodiment 21, however, a cylindrical member 72 that envelopes the cylindrical member 22 and guides the inner wall of the outer cylinder 19 of the pump head 3 is formed integrally with the cap member 7. In this case, the cylindrical member 22 may be made to function so that its inner diameter guides the inner cylinder 20 of the pump head 3.

### EMBODIMENT 23

FIG. 60 show Embodiment 23 of the pump of this invention, wherein (a) is a main part front view of a liquid container with this pump 1, and (b) is a main part longitudinal sectional view of the same.

In this pump 1, the cylindrical portion above the flange portion 10 of the cylindrical member 19 shown in the above-described Embodiment 3 is not provided, and a cylindrical member 72 that guides the outer wall of the inner cylinder of the pump head 3 is formed integrally with the cap member 7. Or, in place of this cylindrical member 72, it is also possible that almost the same construction is realized by making the cylindrical member 22 to function so that its inner diameter guides the inner cylinder of the pump head 3. On the outer circumference near the lower end of the inner cylinder 20 of the pump head 3, a projection 44 is formed. A plurality (three in FIG. 60) of vertical grooves 70 that engage with this projection 44 and have different lengths are formed in the cylindrical member 72, and these form a stopper in conjunction with the projection 44.

This pump 1 constructed as mentioned above is used in the same manner as in the above-described FIG. 58.

FIG. 61 shows a means for limiting the rise of the pump head 3 when the pump head 3 is pushed down. Namely, the lower end of the vertical groove 70 is extended horizontally so as to have an L-shape, whereby the rise of the pump head is limited and locked by pushing the pump head 3 down and further rotating the pump head so that the projection 44 engages with this horizontal groove 75.

Industrial Applicability

In the pump with a function for measuring a fixed amount of discharge of the invention constructed as described above, it is not necessary to discharge the contents accumulating inside the pump cylinder when fixing the pump head by pushing the pump head down, and therefore, while wasteful discharge is prevented, the pump head can be securely fixed. Since the discharge amount can be adjusted in a range from fixation to the maximum discharge amount, measuring and discharge become easier. Furthermore, even while the setting can be easily made, the accuracy is high and the setting can be easily continuously kept.

Furthermore, in the pump with a function for measuring a fixed amount of discharge of this invention, wasteful discharge is prevented and the pump head can be securely fixed. Furthermore, measurement of a discharge amount is adjustable in a stepped manner in a range from fixation to the maximum discharge amount, and in addition, the measuring accuracy is high even while the setting is extremely easy.

Thereby, fixation of the pump head without wasteful discharge and stepless adjustments of the discharge amount which are difficult to achieve in the prior arts can be simultaneously realized due to the simplified mechanism.

In addition, since the number of parts to be added for obtaining these working effects of the invention can be minimized, the working effects can be maximized without a remarkable increase in cost in comparison with the conventional pumps. Furthermore, this construction can be realized without changing the container contents discharge mechanism of the pump itself, and the construction is made up by only replacing a part of the components of pumps currently available, so that its usability and versatility are extremely high.

### BRIEF DESCRIPTION OF THE DRAWINGS

FIG. 1 is a front view partially including a sectional view of the container with the pump showing Embodiment 1 of the invention.

FIG. 2 is a central longitudinal sectional view of the same.

FIG. 3 are main part front views showing working of the same, wherein (a) shows a pump head fixed condition and (b) shows a maximum discharge amount condition.

FIG. 4 are main part front views showing working of another example of a stopper of this pump, wherein (a) shows a pump head fixed condition, and (b) shows a maximum discharge amount condition.

FIG. 5 is a main part front view showing Embodiment 2 of the invention.

FIGS. 6(a) and 6(b) are partial sectional views of a pump head.

FIG. 7 is a partial sectional view of a piston head showing another example of a stopper.

FIGS. 8(a) and 8(b) are conceptual views showing shape examples of a flat portion.

FIG. 9 is a partial sectional view of a piston head showing another example of a stopper.

FIG. 10 are main part sectional views showing Embodiment 3 of the invention, wherein (a) shows a pump head fixed condition and (b) shows a condition with the maximum discharge amount.

FIG. 11 show Embodiment 4 of the invention, wherein (a) is a main part front view partially including a sectional view, and (b) is a sectional view along A-A.

FIG. 12 show Embodiment 5 of the invention, wherein (a) is a main part front view and (b) is a main part central longitudinal sectional view.

FIG. 13 is a perspective view showing the stopper and the comb-shaped groove of the same.

FIGS. 14(a) through 14(d) are main part front views showing working of the same.

FIG. 15 show another construction example of a stopper, wherein (a) is a main part front view and (b) is a main part central longitudinal sectional view.

FIG. 16 is a perspective view showing the stopper and the comb-shaped groove of the same.

FIG. 17 show Embodiment 6 of the invention, wherein (a) is a main part front view and (b) is a main part central longitudinal sectional view.

FIG. 18 is a perspective view showing the stopper and the comb-shaped groove of the same.

FIGS. 19(a) through 19(d) are main part front views showing working of the same.

FIG. 20 is a conceptual view showing another example of the comb-shaped groove.

FIGS. 21(a) and 21(b) are main part front views showing construction examples of the same.

FIG. 22 show Embodiment 7 of the invention, wherein (a) is a main part front view and (b) is a stopper perspective view.

FIG. 23 is a main part front view showing a condition where the stopper is attached.

FIGS. 24(a) and 24(b) are main part side views showing working of the same.

FIG. 25 show Embodiment 8 of the invention, wherein (a) is a main part front view and (b) is a main part central longitudinal sectional view.

FIGS. 26(a) and 26(b) are cross sectional views showing conditions of stopper attachment of the same.

FIGS. 27(a) through 27(d) are main part front views showing working of the same.

FIGS. 28(a) through 28(d) are conceptual views showing another example of a stopper.

FIGS. 29(a) through 29(d) are conceptual views showing another example of a stopper.

FIGS. 30(a) and 30(b) are conceptual views showing another engagement method of the stopper as Embodiment 9 of this invention.

FIG. 31 are front views partially including sectional views of a container with a pump showing Embodiment 10 of the invention.

FIGS. 32(a) through 32(d) are main part front views partially including sectional views showing working of the same.

FIG. 33 are main part front views partially including sectional views showing Embodiment 11 of this invention, wherein (a) shows a piston fixing position and (b) shows the maximum amount discharge position.

FIG. 34 are main part front views partially including sectional views showing Embodiment 12 of the invention, wherein (a) shows a piston fixing position and (b) shows the maximum amount discharge position.

FIG. 35 are main part front views partially including sectional views showing Embodiment 13 of the invention, wherein (a) shows a piston fixing position and (b) shows the maximum amount discharge position.

FIG. 36 are main part longitudinal sectional views showing Embodiment 14 of the invention, wherein (a) shows a condition where a stopper 4 is set at a pump head fixing position and (b) shows a condition where the stopper 4 is set at the maximum discharge amount position.

FIG. 37(a) is a plan view of a stopper 4, and

FIG. 37(b) is across sectional view of a connecting tube 18.

FIG. 38 show Embodiment 15 of the invention, wherein (a) is a main part front view, and (b) is a main part central longitudinal sectional view.

FIGS. 39(a) through 39(d) are main part front views showing working of the same.

FIGS. 40(a) through 40(d) are conceptual views showing another example of a stopper.

FIG. 41 shows Embodiment 17 of this invention.

FIGS. 42(a) and 42(b) are a front view and a side view showing a stopper attached condition.

FIGS. 43(a) and (b) are a front view and a side view showing another construction example of a stopper.

FIG. 44 show Embodiment 17 of the invention, wherein (a) is a main part front view, and (b) is a main part central longitudinal sectional view.

FIG. 45 is a perspective view showing a stopper and a comb-shaped groove.

FIGS. 46(a) through 46(d) are main part front views showing working of the same.

FIG. 47 show Embodiment 18 of this invention, wherein (a) is a main part front view and (b) is a main part central longitudinal sectional view.

FIG. 48 is a perspective view showing the stopper and the comb-shaped groove of the same.

FIGS. 49(a) through 49(d) are main part front views showing working of the same.

FIG. 50 show Embodiment 19 of the invention, wherein (a) is a main part front view and (b) is a main part central longitudinal sectional view.

FIGS. 51(a) and 51(b) are across sectional vie wand a perspective view showing the stopper and the comb-shaped groove of the same.

FIGS. 52(a) through 52(d) are main part front views showing working of Embodiment 19.

FIG. 53 is a conceptual view showing another example of a comb-shaped groove.

FIGS. 54(a) and (b) are main part front views showing a construction example of the same.

FIG. 55 show Embodiment 20 of the invention, wherein (a) is a main part front view and (b) is a main part central longitudinal sectional view.

FIGS. 56(a) through 56(d) are main part sectional views showing working of the same. FIG. 57 show Embodiment 21 of the invention, wherein (a) is a front view and (b) is a longitudinal sectional view.

FIGS. 58(a) through 58(d) are main part sectional views showing working of the same.

FIG. 59 show Embodiment 22 of the invention, wherein (a) is a front view and (b) is a longitudinal sectional view.

FIG. 60 show Embodiment 23 of the invention, wherein (a) is a front view and (b) is a longitudinal sectional view.

FIG. 61 is a main part front view showing a formation example of the stopper.

FIG. 62 is a conceptual view showing a conventional pump head fixing method.

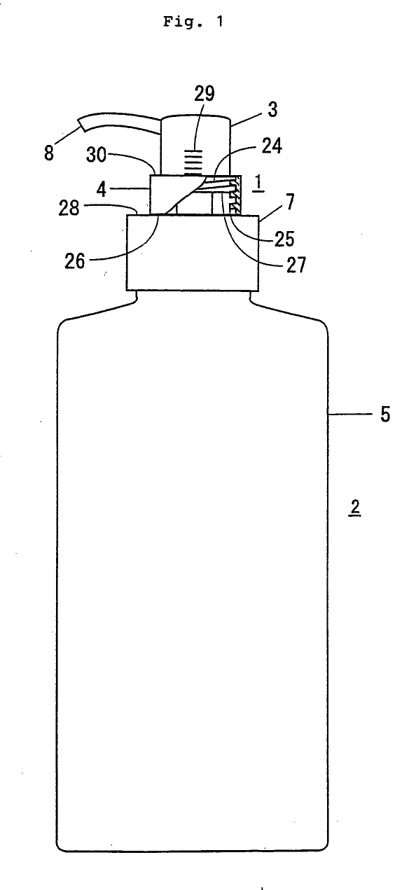

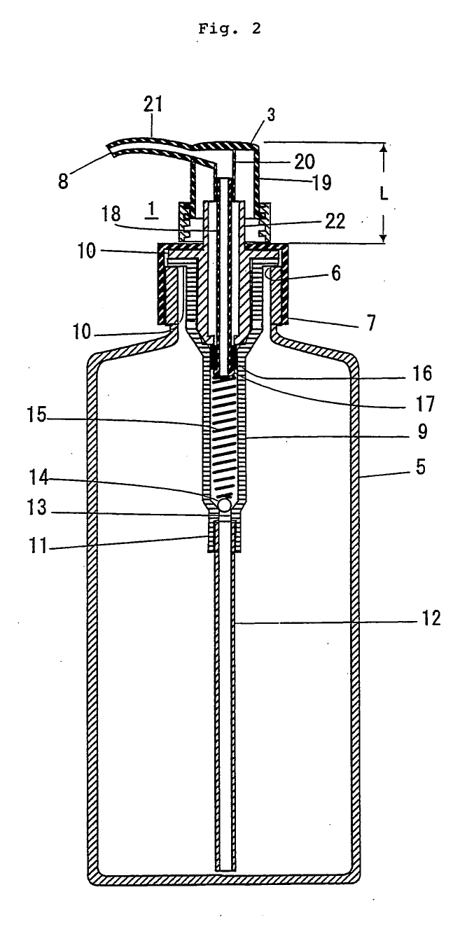

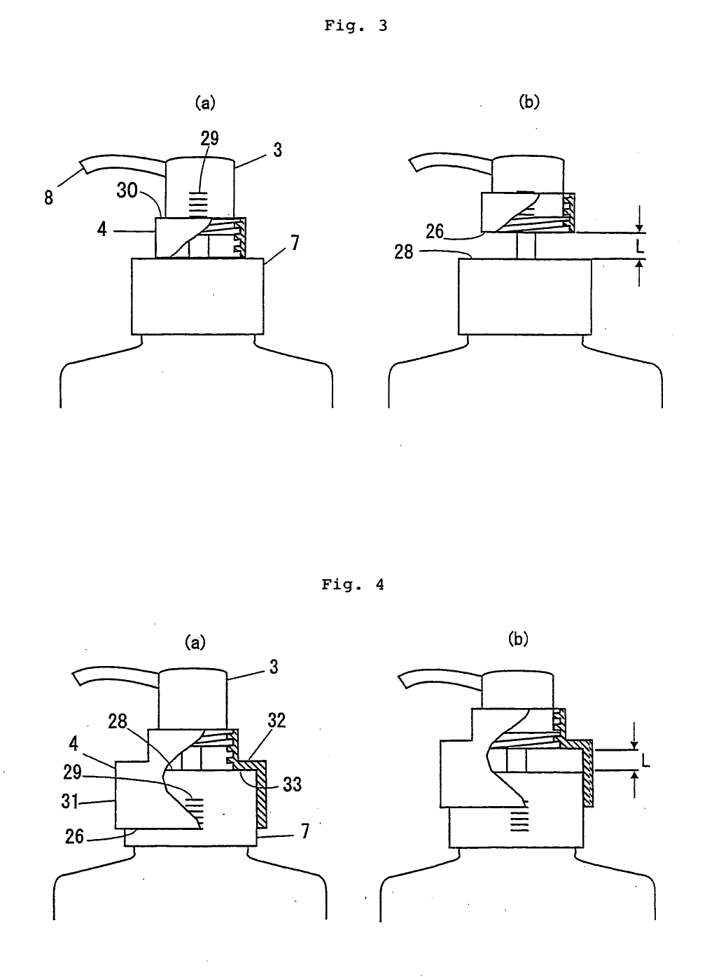

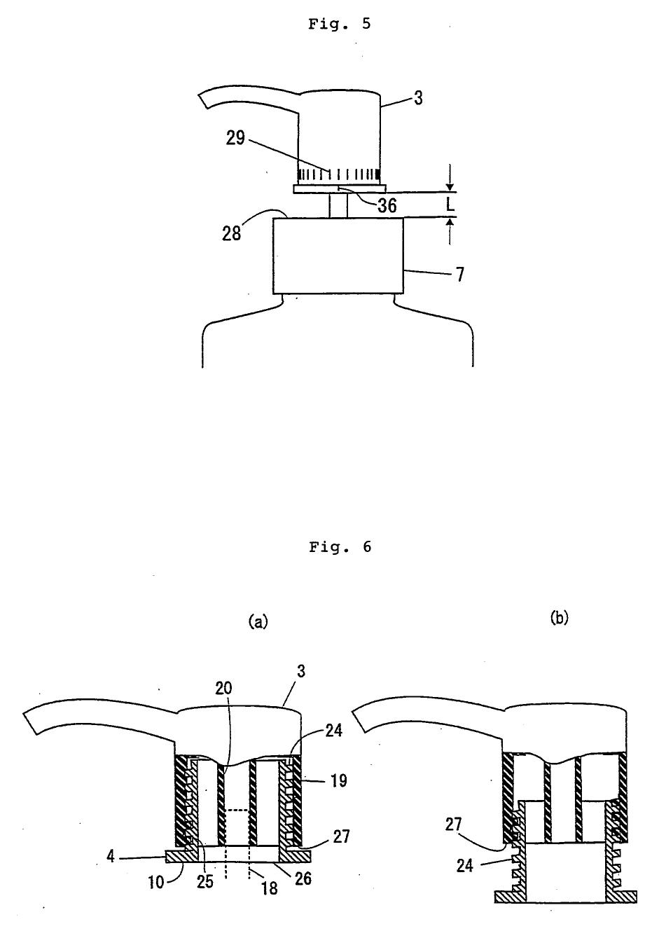

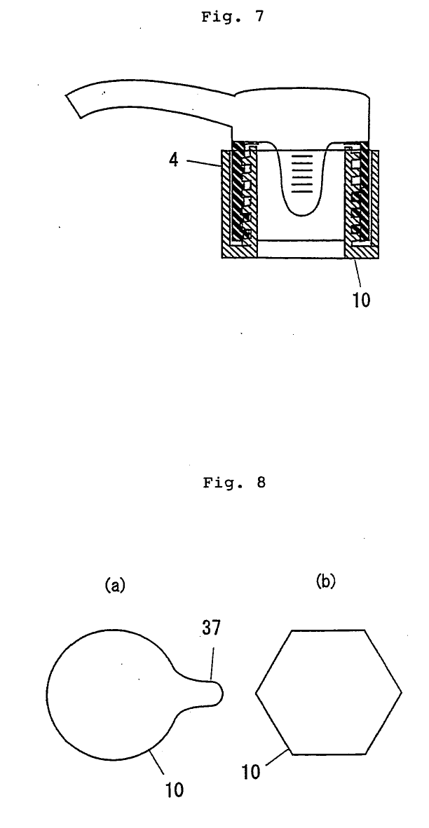

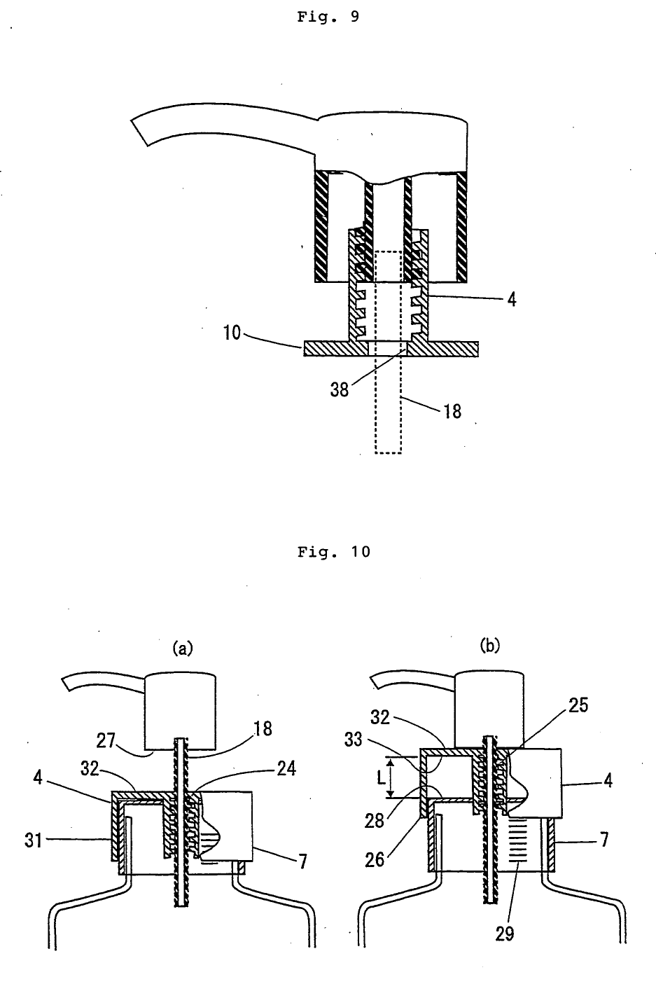

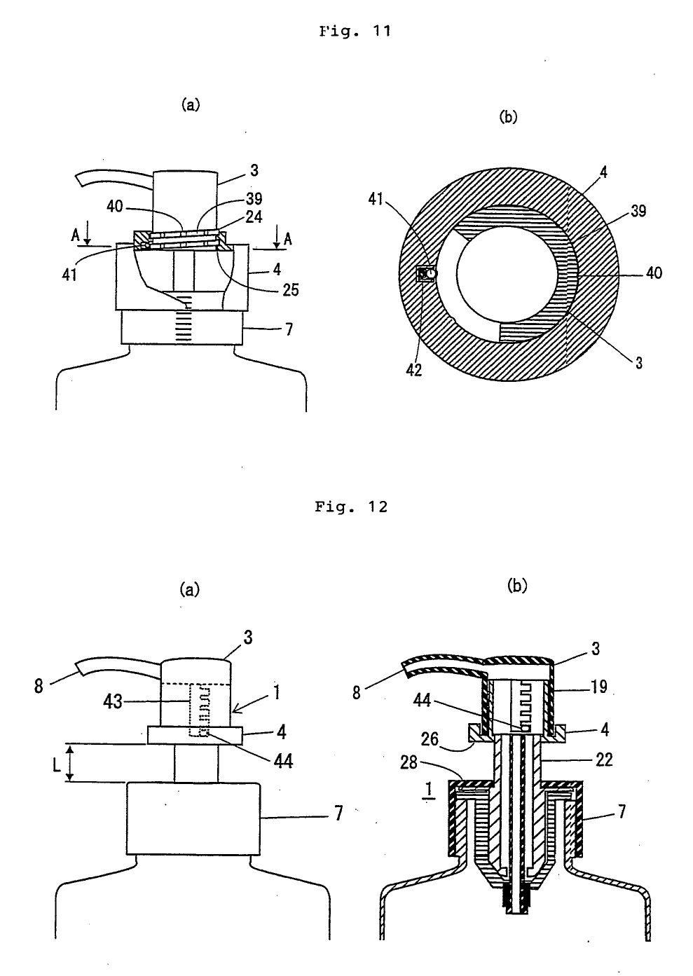

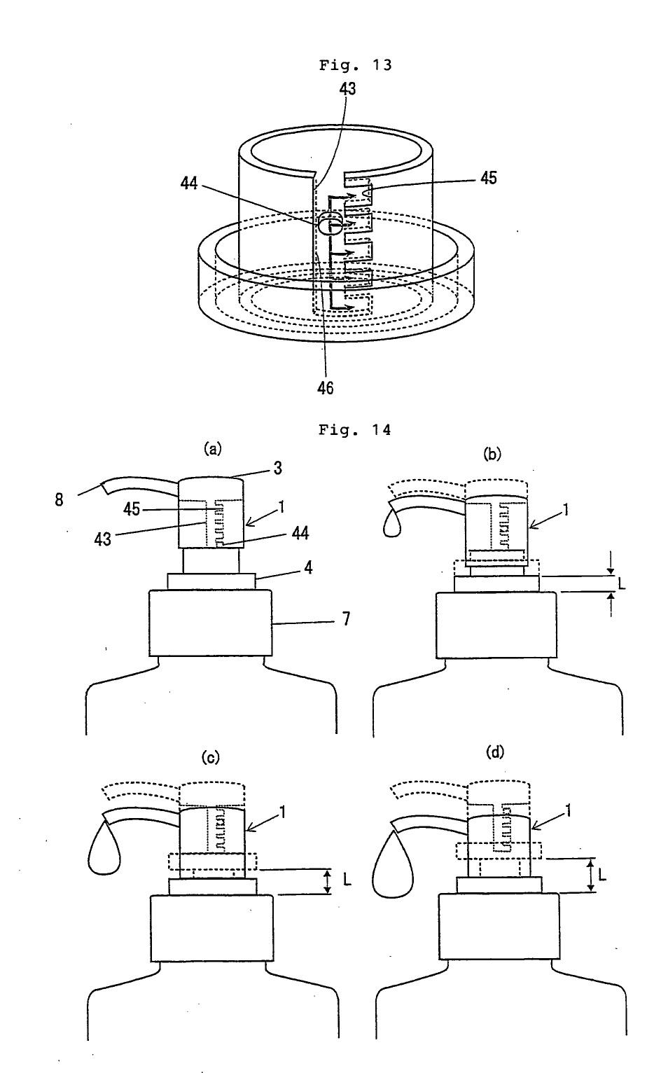

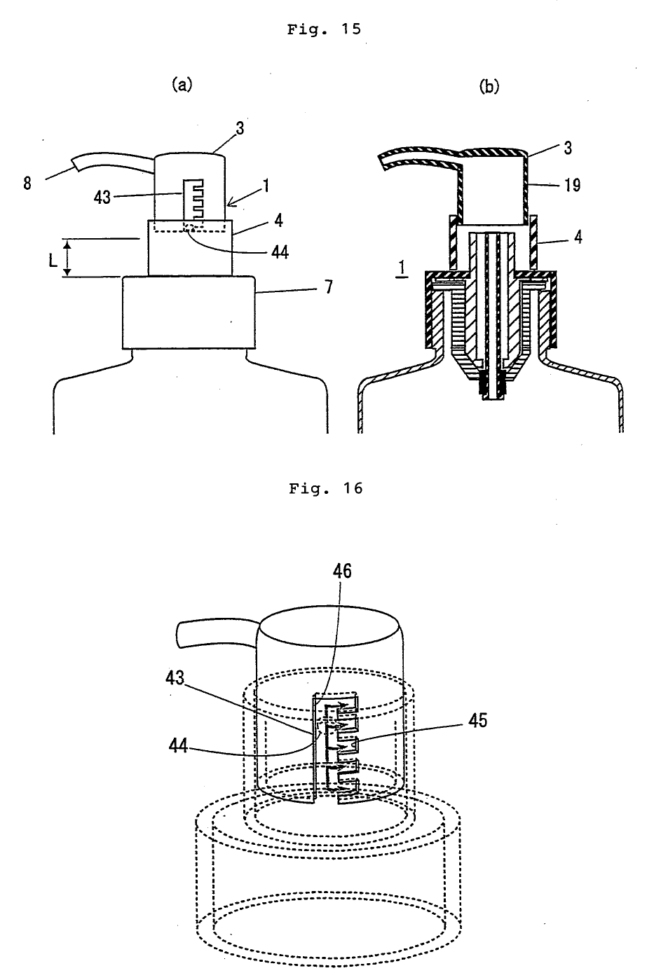

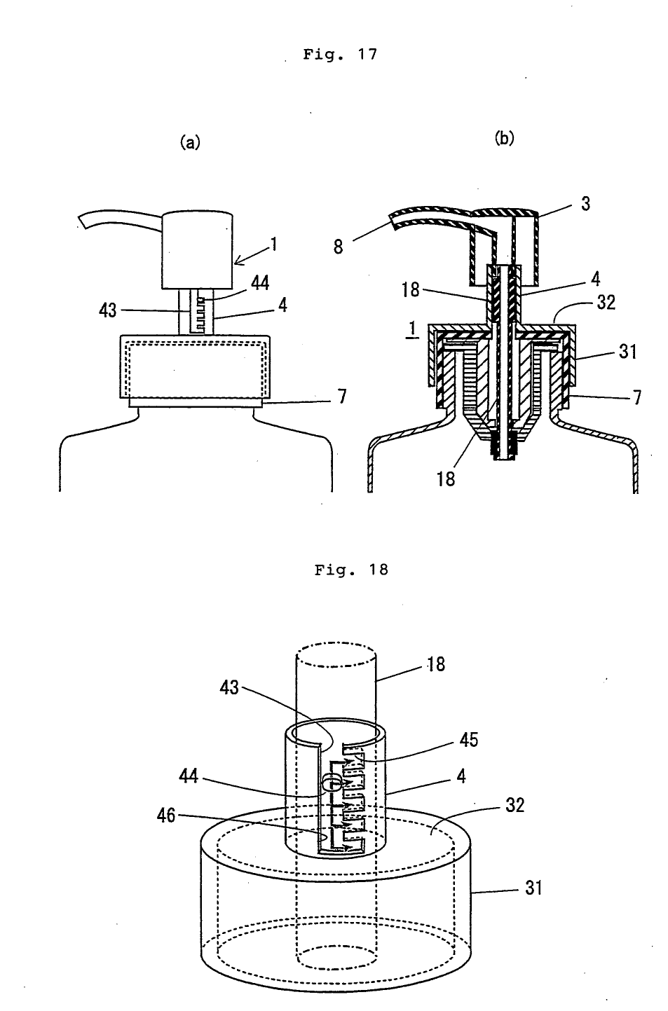

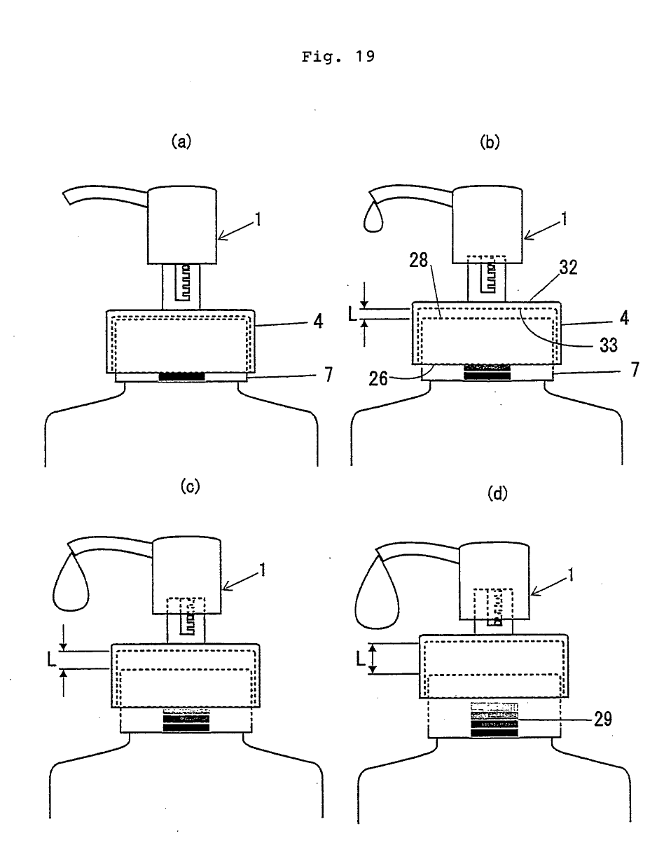

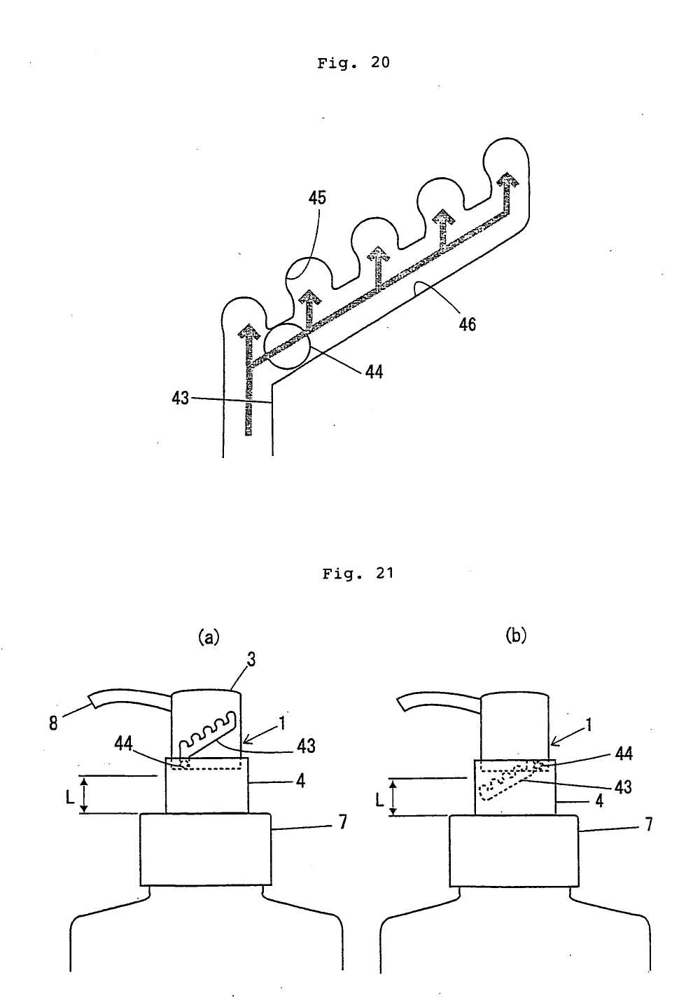

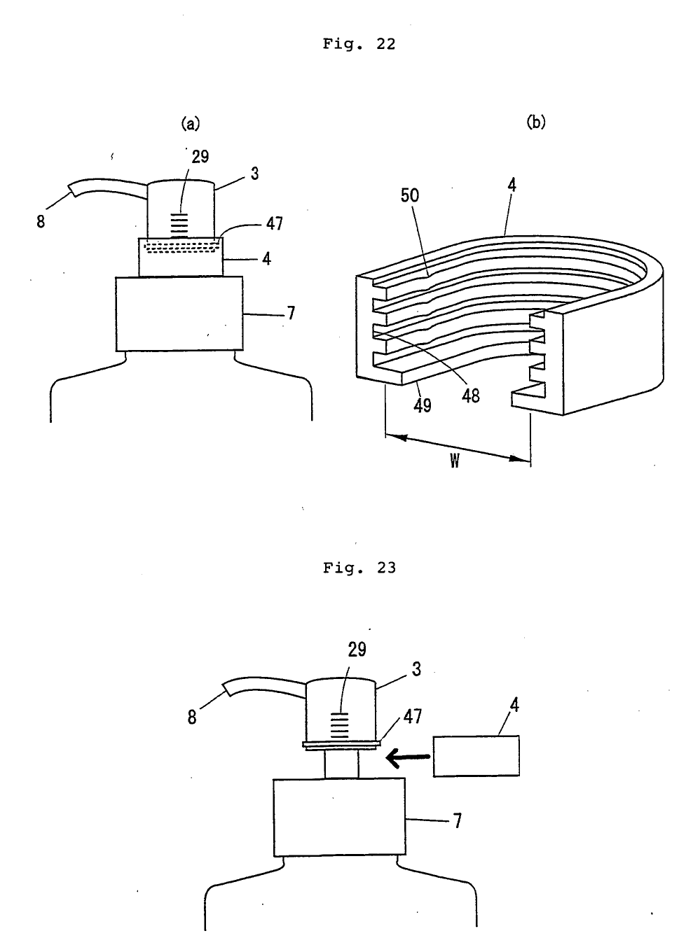

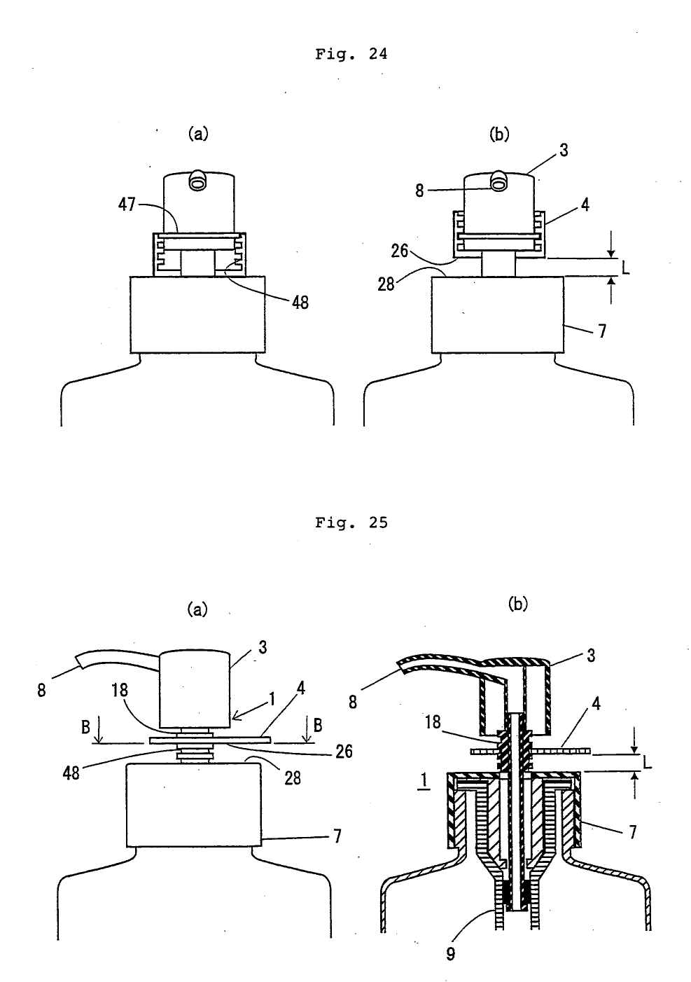

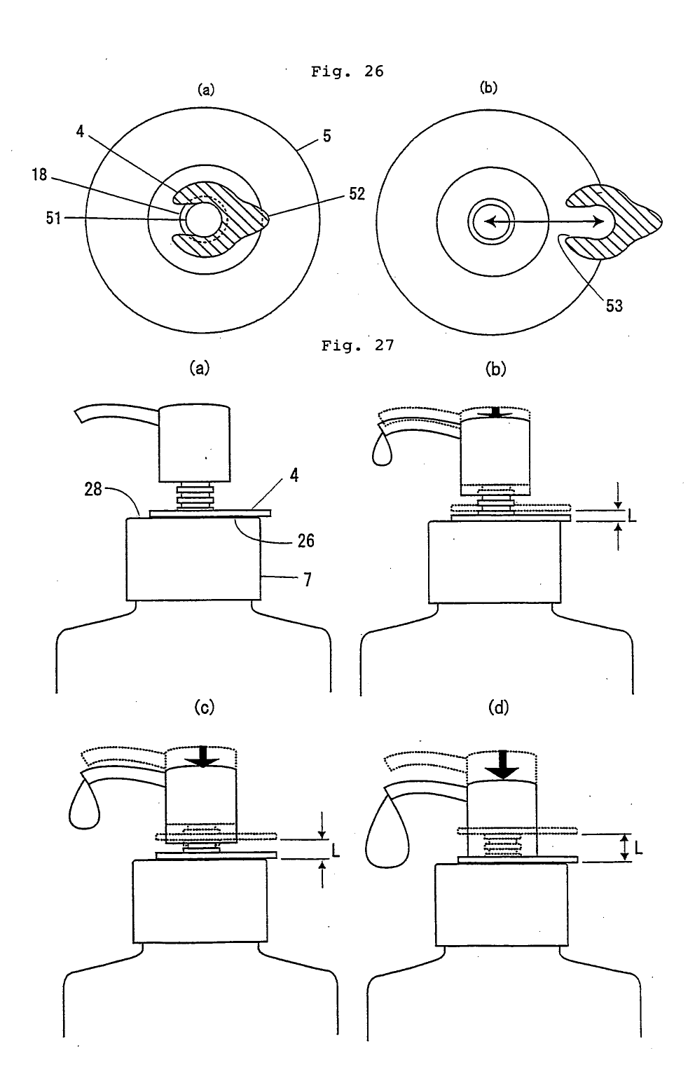

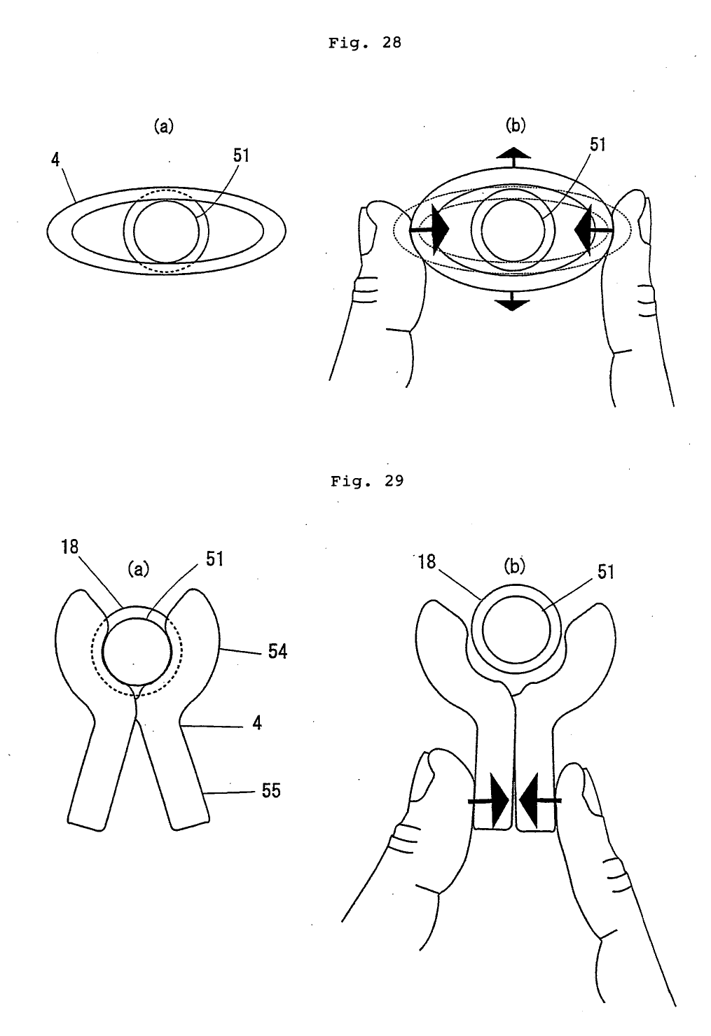

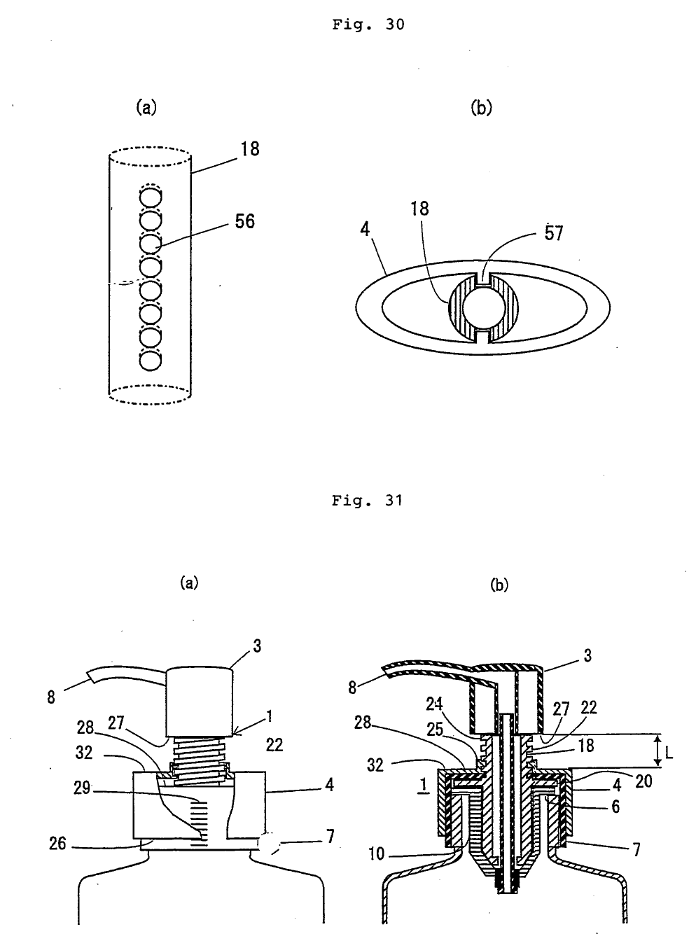

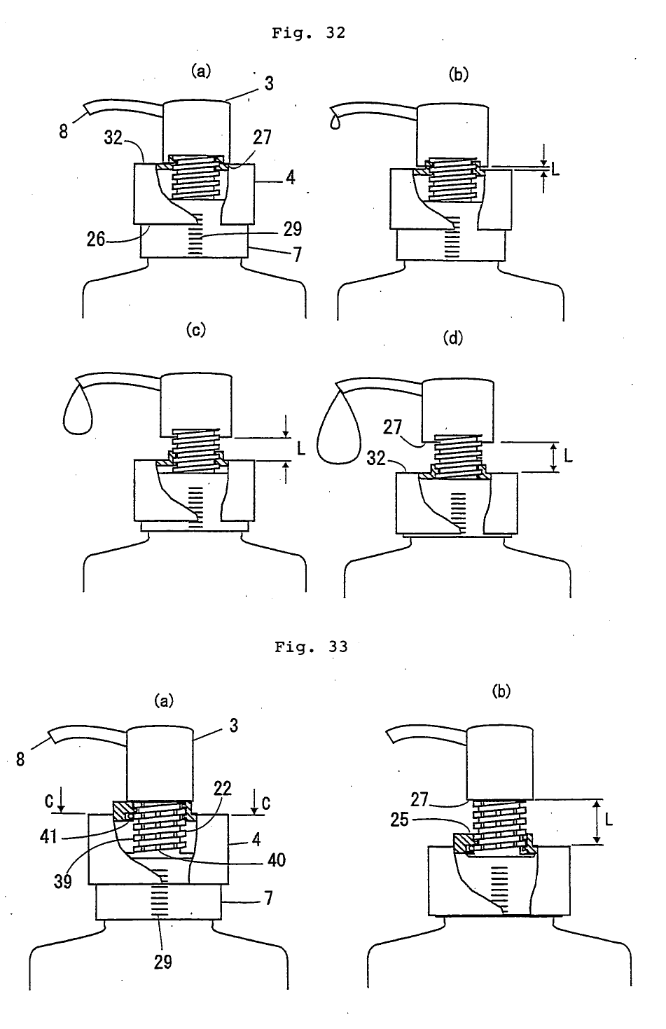

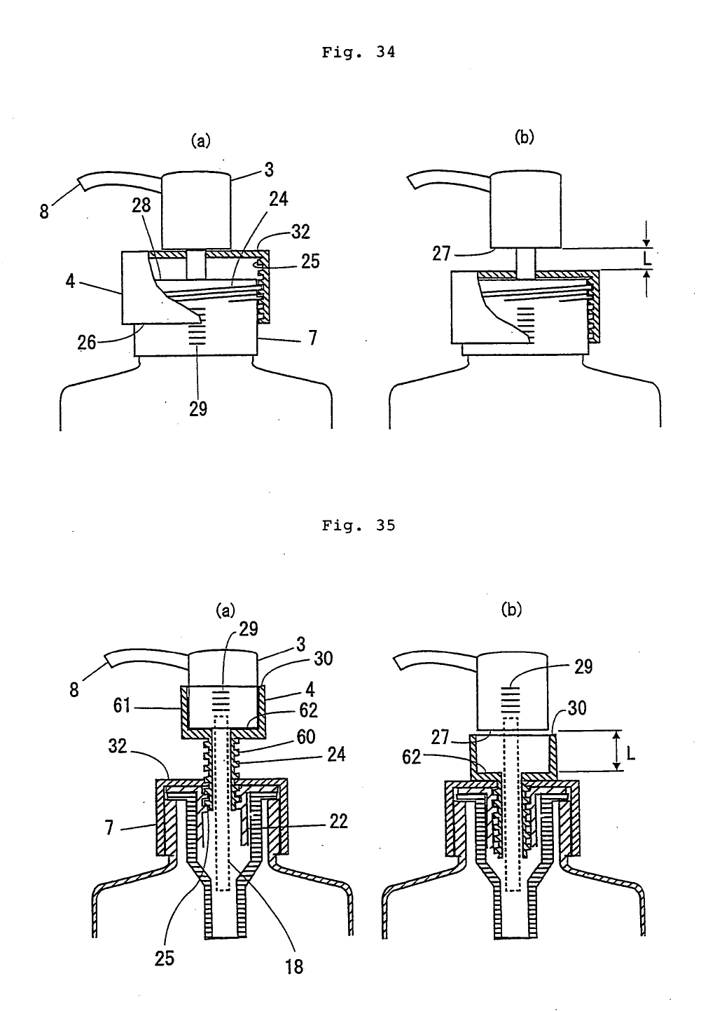

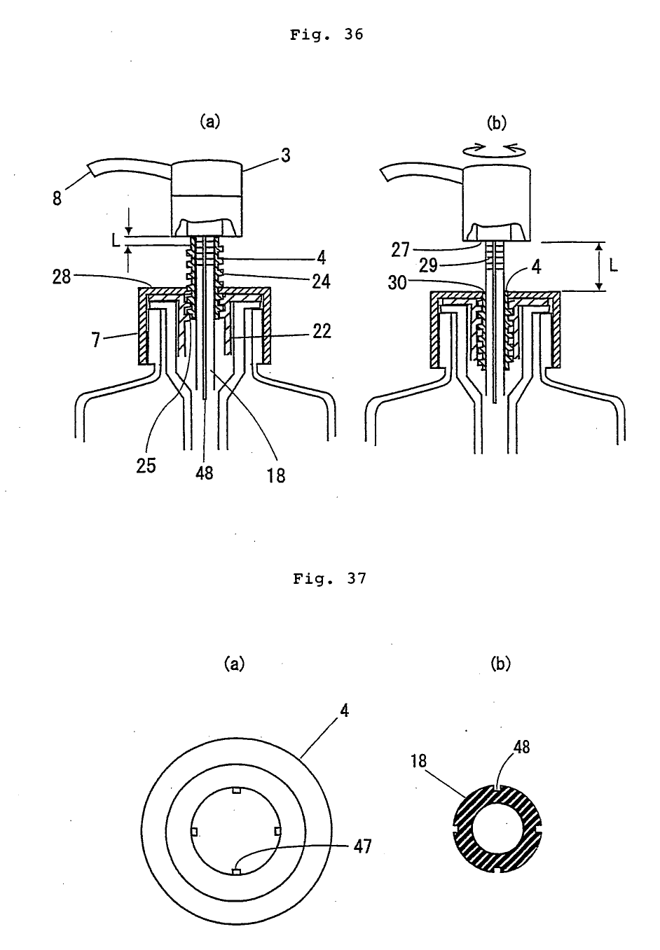

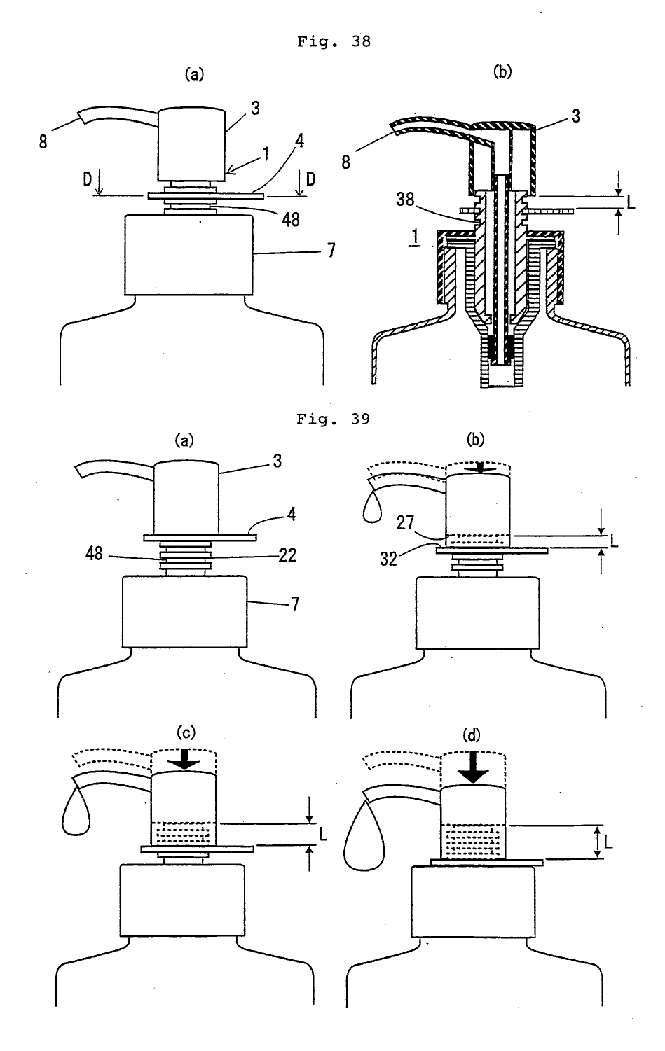

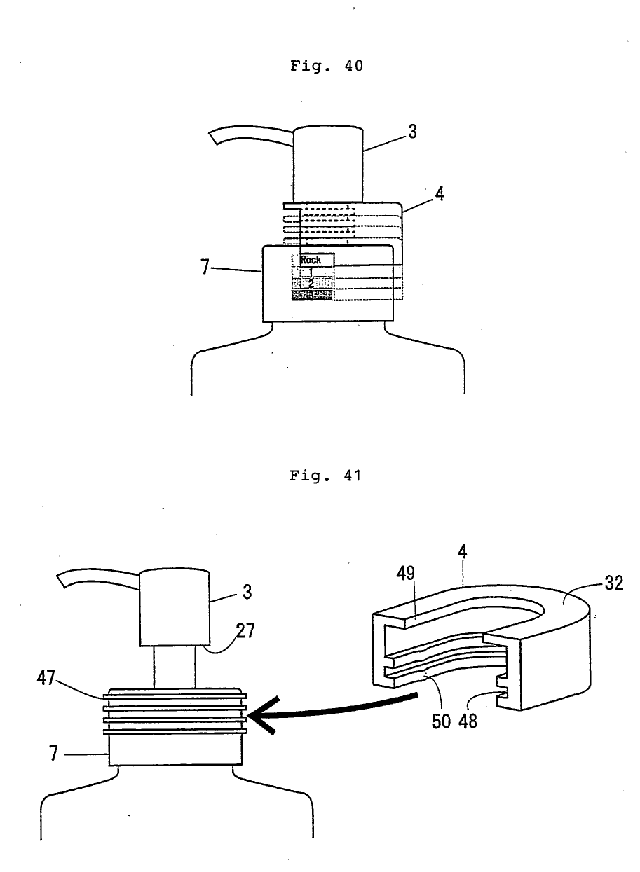

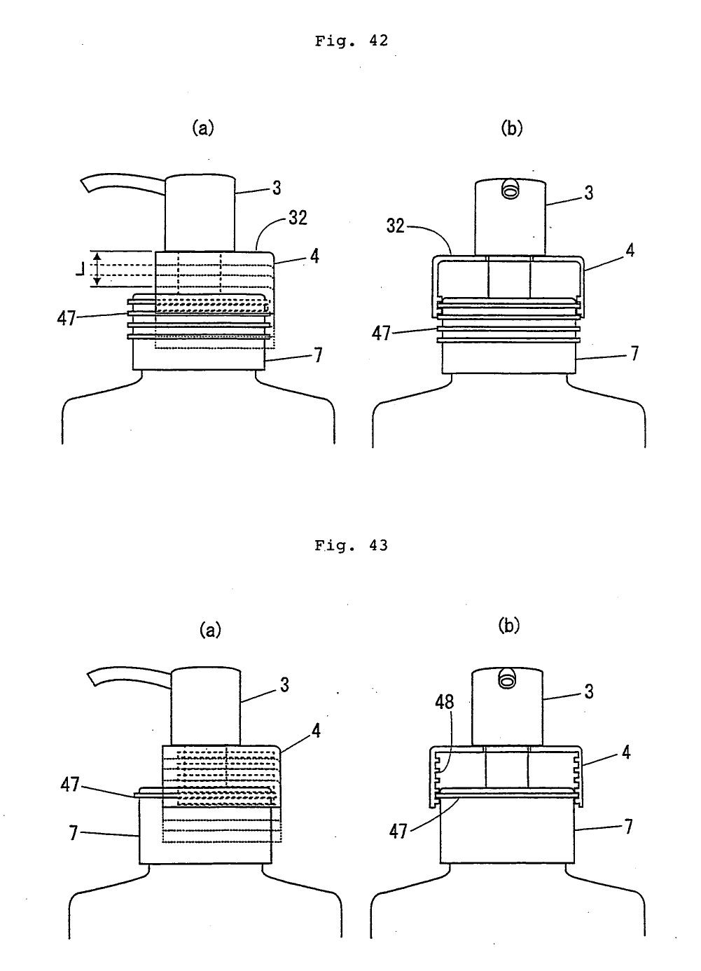

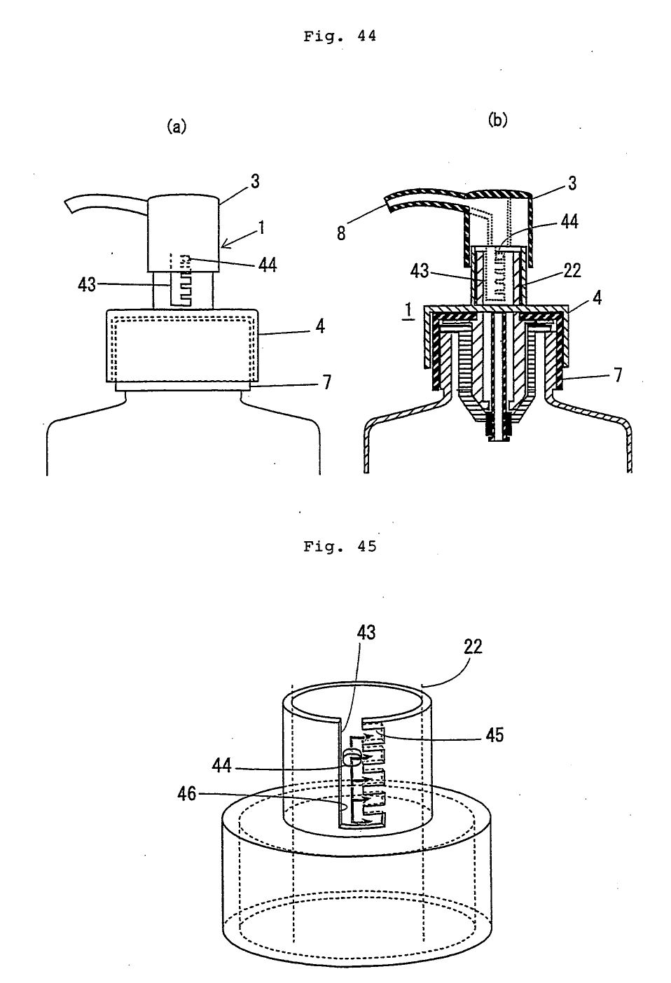

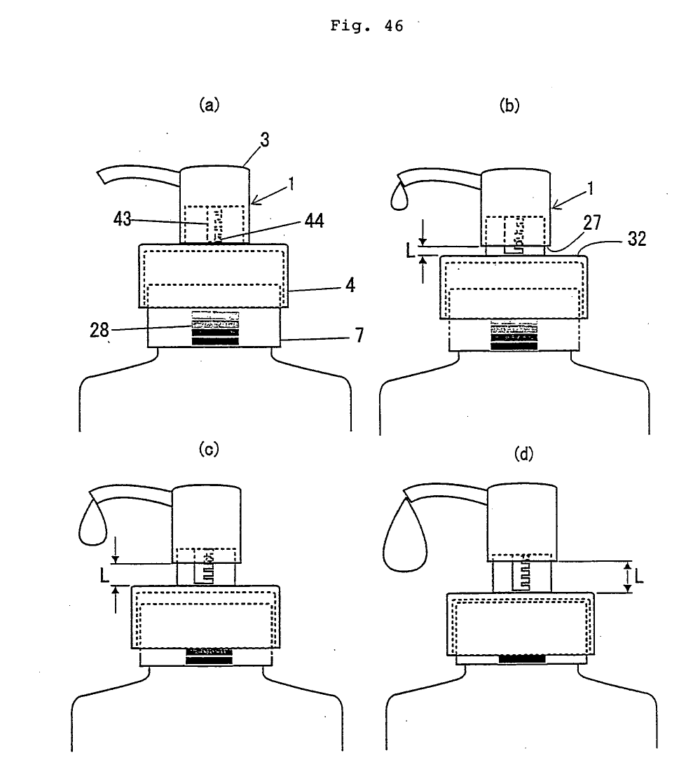

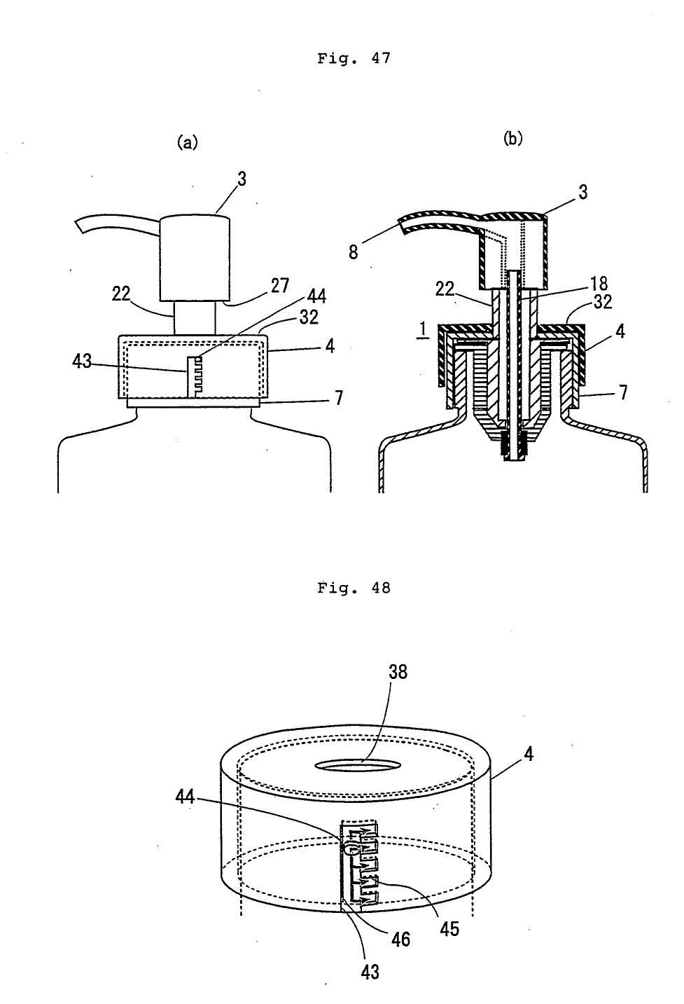

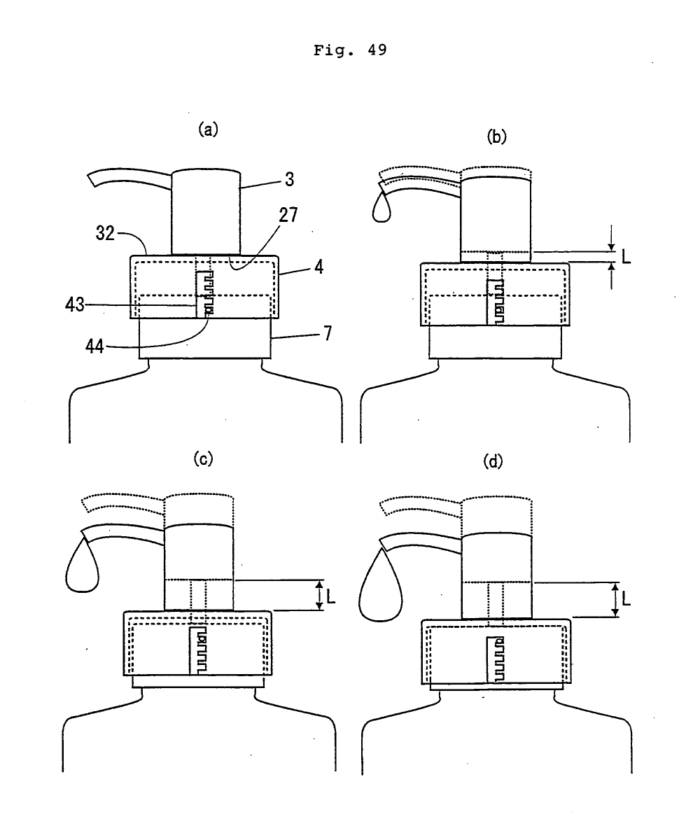

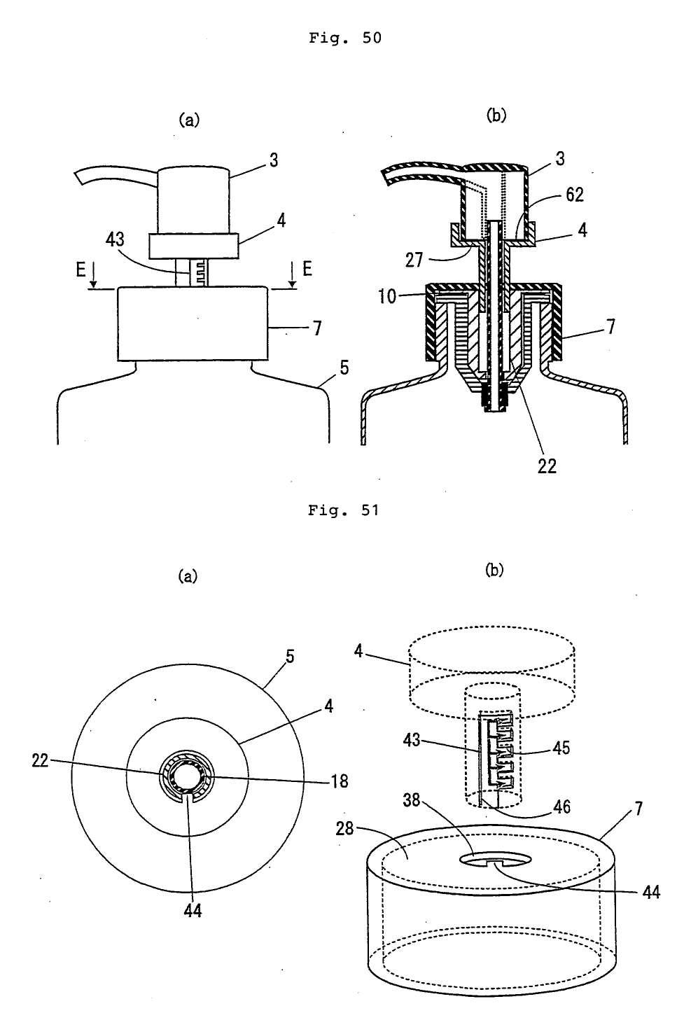

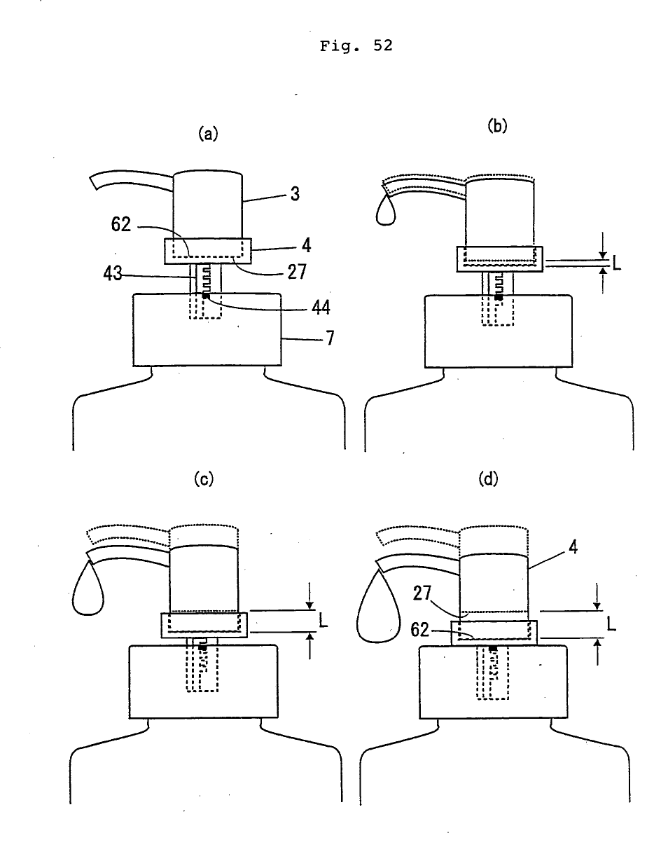

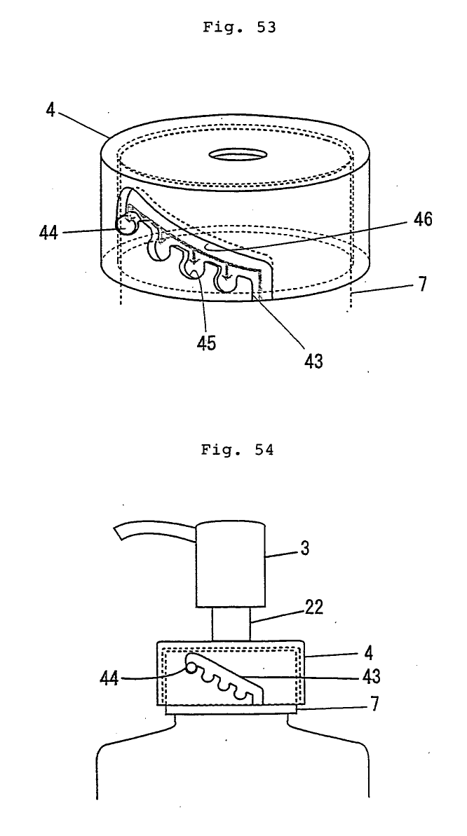

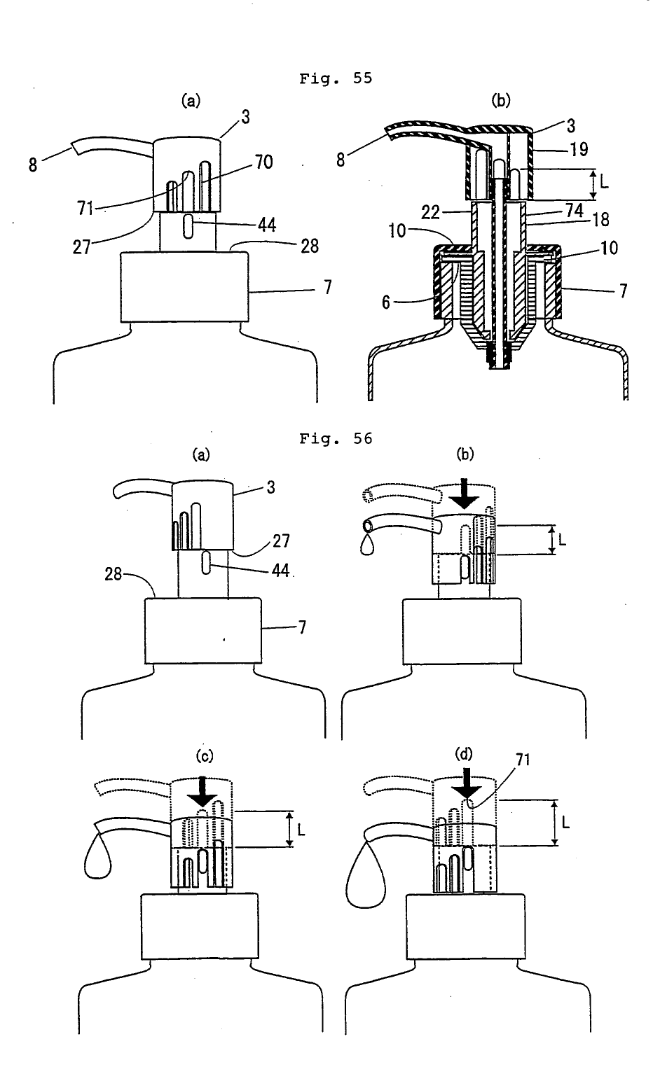

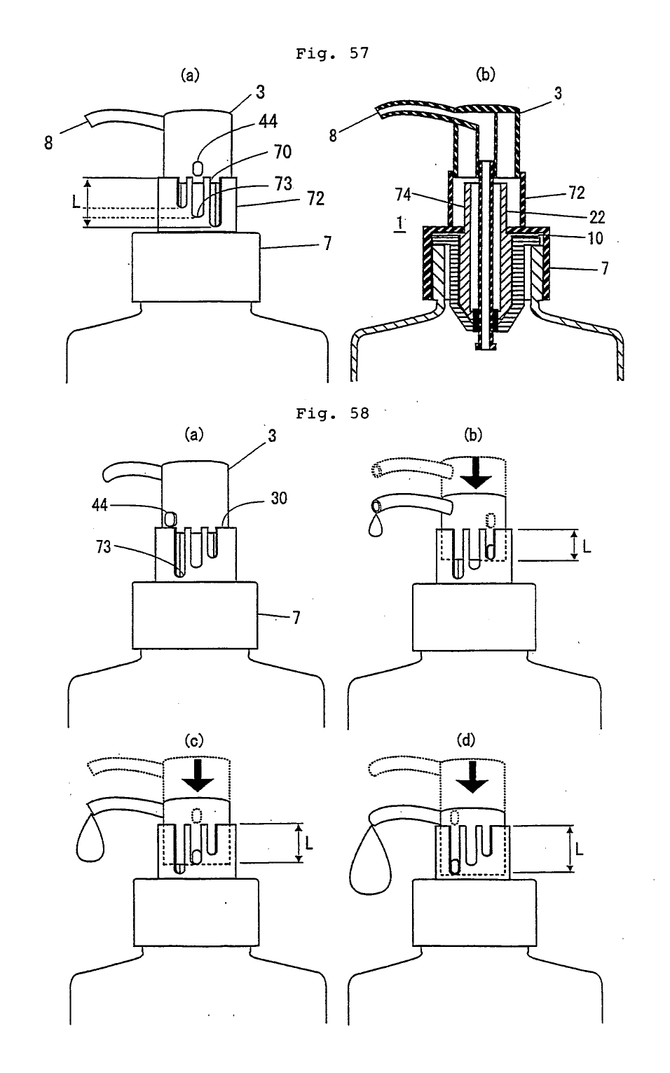

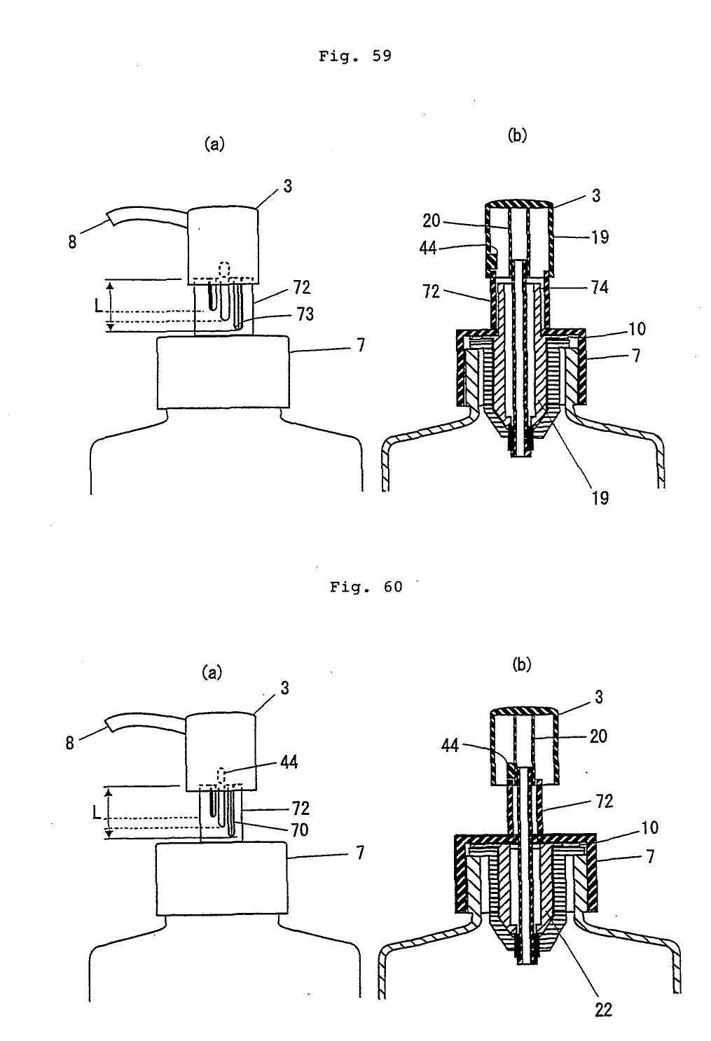

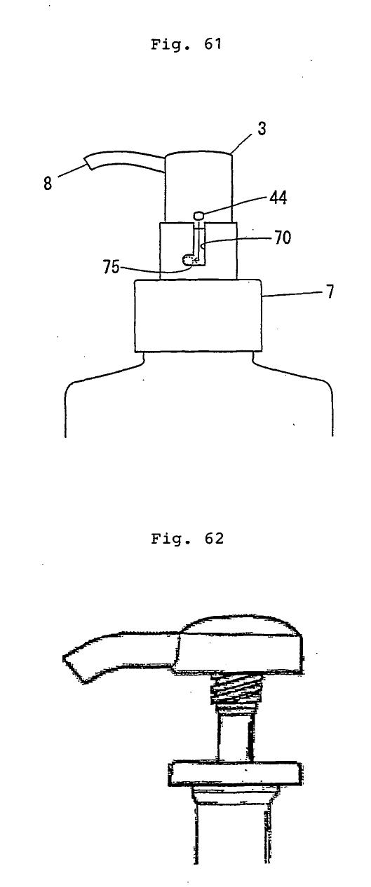

1. A pump with a function of measuring a fixed amount in a way that the amount to be discharged is adjustable, which is a push-down liquid pump that forms a part of a lid body of a liquid container and dispenses and discharges a fixed amount of liquid from inside of a container main body by a push-down operation of a pump head, wherein the pump comprises
a pump head that lowers when the pump head is pushed down,
a movable member that lowers together with the pump head, and
a means for limiting the push-down amount of the pump head, which is provided for the pump head and the movable member in a movable manner so that the amount to be pushed down of the pump head is adjustable between zero and the maximum, whereby a fixed amount corresponding to the push-down amount of the pump head is measured, dispensed and discharged.

2. The pump with a function of measuring a fixed amount in a way that the amount to be discharged is adjustable according to claim 1, wherein the push-down amount limiting means of the pump head has a freely extensible means which makes the lower end of the pump head extensible downward, and the pump head push-down amount is adjusted by the freely extensible means in a range from zero to the maximum according to the amount of lowering of the lower end of the pump head.

3. The pump with a function of measuring a fixed amount in a way that the amount to be discharged is adjustable according to claim 1, wherein the push-down amount limiting means of the pump head comprises a stopper, which is provided in a movable manner for a connecting tube that connects the pump head and a piston inside a pump cylinder, so that the stopper limits an entering amount of the connecting tube into the pump cylinder when the pump head is pushed down and adjusts the pump head push-down amount in a range from zero to the maximum by means of the stopper position according to the entering amount of the connecting tube.

4. The pump with a function of measuring a fixed amount in a way that the amount to be discharged is adjustable according to anyone of claims 1 to 3, wherein the push-down amount adjusting mechanism of the push-down amount limiting means of the pump head enables stepless adjustments by screwing the movable stopper and its supporting member together.

5. The pump with a function of measuring a fixed amount in a way that the amount to be discharged is adjustable according to claim 4, wherein the supporting member rotatably supports the stopper and, on its outer circumference at a desired portion, is provided with engageable portions at arbitrarily divided positions of the outer circumference, and the stopper is provided with an engaging means that engages with the engageable portions, whereby a moderate feeling is given to the rotation of the stopper.

6. The pump with a function of measuring a fixed amount in a way that the amount to be discharged is adjustable according to any one of claims 1 to 3, wherein the push-down amount limiting means of the pump head has such a push-down amount adjusting mechanism that each of the movable stopper and its supporting member is provided with an alternative of a comb-shaped groove or a projection that engages with the groove and moves within the groove in a reciprocal manner, and the projection is engaged with the comb-shaped groove at a projection fixing position to move the stopper in a stepped manner for adjustment.

7. The pump with a function of measuring a fixed amount in a way that the amount to be discharged is adjustable according to any one of claims 1 to 3, wherein the push-down amount limiting means of the pump head has such a push-down amount adjusting mechanism that each of the movable stopper and its supporting member is provided with an alternative of a projecting thread or a thread groove row that engages with the projecting thread in a reciprocal manner, and the projecting thread is engaged with an arbitrary thread groove of the thread groove row to move the stopper in a stepped manner for adjustment.

8. The pump with a function of measuring a fixed amount in a way that the amount to be discharged is adjustable according to any one of claims 1 to 3, wherein the push-down amount limiting means of the pump head has such a push-down amount adjusting mechanism that the stopper supporting member is provided with a thread groove row and the movable stopper is provided with an engaging means that engages with the thread groove row, and the engaging means is engaged with an arbitrary thread groove of the thread groove row to move the stopper in a stepped manner for adjustment.

9. The pump with a function of measuring a fixed amount in a way that the amount to be discharged is adjustable according to claim 8, wherein the stopper is formed into a plate shape and the engaging means is a notch that fits the cross sectional shape of the thread groove bottom portion, and the stopper is inserted into and engaged with an arbitrary thread groove.

10. The pump with a function of measuring a fixed amount in a way that the amount to be discharged is adjustable according to claim 8, wherein the stopper is formed into an annular shape from an elastic material and constructed so that portions opposite each other of the annular shape sandwich a cross sectional shape of the thread groove bottom portion in normal conditions, and the engaging means elastically deforms the stopper to make and release the engagement with the thread groove.

11. The pump with a function of measuring a fixed amount in a way that the amount to be discharged is adjustable according to claim 8, wherein the engaging means is structured so as to pinch the cross sectional shape of the thread groove bottom portion in a movable manner.

12. The pump with a function of measuring a fixed amount in a way that the amount to be discharged is adjustable in any one of claims 1 to 3, wherein the push-down amount limiting means of the pump head has such a push-down amount adjusting mechanism that an engaging hole row is made in the stopper supporting member, an engaging means that engages with any one engaging hole of the engaging hole row is provided for the movable stopper, and the engaging means is engaged with an arbitrary engaging hole of the engaging hole row, whereby the stopper is moved in a stepped manner for adjustment.

13. A pump with a function of measuring a fixed amount in a way that the amount to be discharged is adjustable, which is a push-down liquid pump that forms a part of a lid body of a liquid container and dispenses and discharges a fixed amount of liquid from inside of a container main body by a push-down operation of a pump head, wherein the pump comprises
a pump head,
a fixing member to be fixed to a container main body, which does not move with the pump head when the pump head is pushed down,
and a means for limiting the push-down amount of the pump head, which is provided for the fixing member in a movable manner so that the pump head push-down amount is adjustable between zero and the maximum, whereby a fixed amount according to the push-down amount of the pump head is measured, dispensed and discharged.

14. The pump with a function of measuring a fixed amount in a way that the amount to be discharged is adjustable according to claim 13, wherein in the push-down amount limiting means of the pump head comprises
a cylindrical body, which is to stand up from an opening of a container main body and
a stopper, which is movable upward and downward by using the cylindrical body as a shaft so that the push-down amount of the pump head is adjusted in a range from zero to the maximum according to the position of the stopper.

15. The pump with a function of measuring a fixed amount in a way that the amount to be discharged is adjustable according to claim 13, wherein the push-down amount limiting means of the pump head comprises
a lid body of a container main body; and
a stopper, which is movable upward and downward by using the lid body as a shaft so that the push-down amount of the pump head is adjusted in a range from zero to the maximum according to the position of the stopper.

16. The pump with a function of measuring a fixed amount in a way that the amount to be discharged is adjustable according to claim 13, wherein in the push-down amount limiting means of the pump head comprises
a cylindrical portion, which is to be provided at a center of an opening of a container main body; and
a stopper, which is pivotally supported by the cylindrical portion so that the push-down amount of the pump head is adjusted in a range from zero to the maximum according to the position of the stopper.

17. The pump with a function of measuring a fixed amount in a way that the amount to be discharged is adjustable according to any one of claims 13 to 16, wherein the push-down amount adjusting mechanism of the push-down amount limiting means of the pump head enables stepless adjustments by screwing the movable stopper and its supporting member together.

18. The pump with a function of measuring a fixed amount in a way that the amount to be discharged is adjustable according to claim 17, wherein the supporting member rotatably supports the stopper and, on its outer circumference at a desired portion, is provided with engageable portions at arbitrarily divided positions of the outer circumference, and the stopper is provided with an engaging means that engages with the engageable portions, whereby a moderate feeling is given to the rotation of the stopper.

19. The pump with a function of measuring a fixed amount in a way that the amount to be discharged is adjustable according to any one of claims 13 to 16, wherein the push-down amount limiting means of the pump head has such a push-down amount adjusting mechanism that each of the movable stopper and its supporting member is provided with an alternative of a comb-shaped groove or a projection that engages with the groove and moves within the groove in a reciprocal manner, and the projection is engaged with the comb-shaped groove at a projection fixing position to move the stopper in a stepped manner for adjustment.

20. The pump with a function of measuring a fixed amount in a way that the amount to be discharged is adjustable according to any one of claims 13 to 16, wherein the push-down amount limiting means of the pump head has such a push-down amount adjusting mechanism that each of the movable stopper and its supporting member is provided with an alternative of a projecting thread or a thread groove row that engages with the projecting thread in a reciprocal manner, and the projecting thread is engaged with an arbitrary thread groove of the thread groove row to move the stopper in a stepped manner for adjustment.

21. The pump with a function of measuring a fixed amount in a way that the amount to be discharged is adjustable according to any one of claims 13 to 16, wherein the push-down amount limiting means of the pump head has such a push-down amount adjusting mechanism that the stopper supporting member is provided with a thread groove row and the movable stopper is provided with an engaging means that engages with the thread groove row, and the engaging means is engaged with an arbitrary thread groove of the thread groove row to move the stopper in a stepped manner for adjustment.

22. The pump with a function of measuring a fixed amount in a way that the amount to be discharged is adjustable according to claim 21, wherein the stopper is formed into a plate shape and the engaging means is a notch that fits the cross sectional shape of the thread groove bottom portion, and the stopper is inserted into and engaged with an arbitrary thread groove.

23. The pump with a function of measuring a fixed amount in a way that the amount to be discharged is adjustable according to claim 21, wherein the stopper is formed into an annular shape from an elastic material and constructed so that portions opposite each other of the annular shape sandwich a cross sectional shape of the thread groove bottom portion in normal conditions, and the engaging means elastically deforms the stopper to make and release the engagement with the thread groove.

24. The pump with a function of measuring a fixed amount in a way that the amount to be discharged is adjustable according to claim 21, wherein the engaging means is structured so as to pinch the cross sectional shape of the thread groove bottom portion in a movable manner.

25. The pump with a function of measuring a fixed amount in a way that the amount to be discharged is adjustable in any one of claims 13 to 16, wherein the push-down amount limiting means of the pump head has such a push-down amount adjusting mechanism that an engaging hole row is made in the stopper supporting member, an engaging means that engages with any one engaging hole of the engaging hole row is provided for the movable stopper, and the engaging means is engaged with an arbitrary engaging hole of the engaging hole row, whereby the stopper is moved in a stepped manner for adjustment.

26. A pump with a function of measuring a fixed amount in a way that the amount to be discharged is adjustable in a stepped manner, which is a push-down liquid pump that forms a part of a lid body of a liquid container and pumps up a fixed amount of liquid from the inside of the container main body in response to push-down operation, and is provided with a stopper that limits the push-down amount of the push-down portion provided in a movable manner in a movement space of the pump push-down portion so that the movement amount is adjustable in a stepped manner between a maximum movement amount and an immobile position to measure and dispense a fixed amount corresponding to the push-down amount of the push-down portion, wherein
the stopper is a projection projectedly provided on an outer wall of a tubular member enveloping a connecting tube that connects a pump head and a piston,
the pump head is provided with a plurality of vertical grooves having different lengths, each of which is engageable with the projection to allow the projection to slide vertically, and
when the pump head is pushed down upon fitting the positions of the projection and desired one of the vertical grooves by rotating the pump head, the pump head is pushed down with a stroke limited according to the length of the vertical groove.

27. A pump with a function for measuring a fixed amount in a way that the amount to be discharged is adjustable in a stepped manner, which is a push-down liquid pump that forms a part of a lid body of a liquid container and pumps up a fixed amount of liquid from the inside of the container main body in response to push-down operation, and is provided with a stopper that limits the push-down amount of the push-down portion provided in a movable manner in a movement space of the pump push-down portion so that the movement amount is adjustable in a stepped manner between a maximum movement amount and an immobile position to measure and dispense a fixed amount corresponding to the push-down amount of the push-down portion, wherein
the stopper is a projection projectedly provided on an outer wall of a pump head outer cylinder,
a cylindrical body into which the pump head is to be inserted inserted is provided on a container lid body,
the cylindrical body is provided with a plurality of vertical grooves having different lengths, each of which is engageable with the projection to allow the projection to slide vertically, and
when the pump head is pushed down upon fitting the positions of the projection and desired one of the vertical grooves by rotating the pump head, the pump head is pushed down with a stroke limited according to the length of the vertical groove.

28. A pump with a function for measuring a fixed amount in a way that the amount to be discharged is adjusted in a stepped manner, which is a push-down liquid pump that forms a part of a lid body of a liquid container and pumps up a fixed amount of liquid from the inside of the container main body in response to push-down operation, and is provided with a stopper that limits the push-down amount of the push-down portion provided in a movable manner in a movement space of the pump push-down portion so that the movement amount is adjustable in a stepped manner between a maximum movement amount and an immobile position to measure and dispense a fixed amount corresponding to the push-down amount of the push-down portion, wherein
the stopper is a projection projectedly provided on an inner wall of a pump head outer cylinder,
a cylindrical body which is to bee inserted inside the pump head is provided on a container lid body,
the cylindrical body is provided with a plurality of vertical grooves having different lengths, each of which is engageable with the projection to allow the projection to slide vertically, and
when the pump head is pushed down upon fitting the positions of the projection and desired one of the vertical grooves by rotating the pump head, the pump head is pushed down with a stroke limited according to the length of the vertical groove.

29. A pump with a function for measuring a fixed amount in a way that the amount to be discharged is adjusted in a stepped manner, which is a push-down liquid pump that forms a part of a lid body of a liquid container and pumps up a fixed amount of liquid from the inside of the container main body in response to push-down operation, and is provided with a stopper that limits the push-down amount of the push-down portion provided in a movable manner in a movement space of the pump push-down portion so that the movement amount is adjustable in a stepped manner between a maximum movement amount and an immobile position to measure and dispense a fixed amount corresponding to the push-down amount of the push-down portion, wherein
the stopper is a projection projectedly provided on an outer wall of a pump head inner cylinder,
a cylindrical body which is to be inserted inside the pump head is provided on a container lid body,
the cylindrical body is provided with a plurality of vertical grooves having different lengths, each of which is engageable with the projection to allow the projection to slide vertically, and
when the pump head is pushed down upon fitting the positions of the projection and a desired vertical groove by rotating the pump head, the pump head is pushed down with a stroke limited according to the length of the vertical groove.
